(19) United States
(12) Patent Application Publication
(10) Pub. No.: US 2012/0176558 A1
(43) Pub. Date: Jul. 12, 2012

(54) LIGHTING DEVICE, DISPLAY DEVICE AND TELEVISION RECEIVER

(75) Inventor: Mayumi Nakamura, Osaka-shi (JP)

(73) Assignee: SHARP KABUSHIKI KAISHA, Osaka-shi, Osaka (JP)

(21) Appl. No.: 13/496,219

(22) PCT Filed: Sep. 29, 2010
(86) PCT No.: PCT/JP2010/066887

§ 371 Date: Mar. 15, 2012

(30) Foreign Application Priority Data
Sep. 30, 2009 (JP) 2009-228138

(51) Int. Cl. G02F 1/1335; H04N 3/10; G09F 13/04

(52) U.S. Cl. 348/790; 362/97.1; 349/61; 348/E03.011

(57) ABSTRACT

Uneven brightness caused by displacement of an optical member with respect to a light source is prevented. A backlight unit 12 includes a light source 18, a chassis 14 housing the light source 18, and optical members 15 disposed on a light exit side with respect to the light source 18. The optical members 15 have different optical properties between an area LA overlapping with the light source 18 and an area LN not overlapping with the light source 18. Convex portions 19b are provided on relay connectors 19 as a light source positioning member provided on the light source 18 for positioning the light source 18 with respect to the optical members 15. Cutout portions 33 are provided on a diffuser 30 as an optical member positioning member disposed on the optical members 15 for positioning the optical members 15 with respect to the light source 18. The light source positioning member and the optical member positioning member are fitted to each other to position the light source 18 and the optical members 15 with respect to each other.

### TECHNICAL FIELD

The present invention relates to a lighting device, a display device and a television receiver.

### BACKGROUND ART

A liquid crystal panel used in a liquid crystal display device, such as a liquid crystal television set, does not emit light by itself and requires a separate backlight unit as a lighting device. The backlight unit is installed on the back side (opposite to the display surface) of the liquid crystal panel and includes a chassis with an opening on the side facing the liquid crystal panel, a light source (such as a cold cathode tube) housed in the chassis, and an optical member (such as a diffuser sheet) disposed at the opening of the chassis and used for efficiently transmitting light emitted from the light source toward the liquid crystal panel. An example of this type of backlight unit is discussed in Patent Document 1 indicated below.

In the backlight unit according to Patent Document 1, a dot pattern with different light reflectance is formed on a surface of the optical member that faces the light source. The dot pattern causes the light to be dispersed in a light source arrangement area where the light source is disposed and to be concentrated in a light source non-arrangement area where no light source is disposed, resulting in uniform brightness of illumination light. In this way, uneven brightness can be prevented and display quality can be improved.
Patent Document 1: Japanese Unexamined Patent Publication No. 2008-009369

### Problem to be Solved by the Invention

However, if the optical member having the dot pattern with different reflectance is disposed with displacement with respect to the light source, the position of the dot pattern is also displaced. The position of the dot pattern is set based on the brightness of the light source itself and the arrangement of the light source. As a result, the brightness of illumination light may become non-uniform even if the amount of displacement is very small.

### DISCLOSURE OF THE PRESENT INVENTION

The present invention was made in view of the foregoing circumstances, and an object of the present invention is to prevent uneven brightness due to positional displacement of the optical member.

### Means for Solving the Problem

A lighting device of the present invention may include a light source; a chassis housing the light source; and an optical member disposed on a side from which light from the light source is emitted. The optical member may have different optical characteristics between an area overlapping with the light source and an area not overlapping with the light source, include a light-source-side positioning member disposed on a light-source side and configured to position the light source with respect to the optical member, and further include an optical-member-side positioning member disposed on an optical-member side and configured to position the optical member with respect to the light source. The light source and the optical member may be positioned with respect to each other in a direction along the plane of the optical member with the light-source-side positioning member and the optical-member-side positioning member engaged with each other.

According to this configuration, when the optical characteristics in the optical member differ between the area overlapping with the light source and the area not overlapping with the light source, positional displacement between the light source and the optical member may lead to a failure to exhibit optical characteristics, as designed, in the area overlapping with the light source. In the present invention, the light source and the optical member are positioned by the engagement between the light-source-side positioning member and the optical-member-side positioning member. Due to this positioning based on the engagement, it is possible to exhibit respectively different optical characteristics, as designed, in the area overlapping with the light source and the area not overlapping with the light source.

### BRIEF DESCRIPTION OF THE DRAWINGS

FIG. 1 is an exploded perspective view showing a configuration of a television receiver according to the first embodiment of the present invention;

FIG. 2 is an exploded perspective view showing a schematic configuration of a liquid crystal display device of the television receiver;

FIG. 3 is a cross section view of the liquid crystal display device taken along a short side direction thereof;

FIG. 4 is a cross section view of the liquid crystal display device taken along a long side direction thereof;

FIG. 5 is a plan view showing a layout of a hot cathode tube, a chassis, support members, and connectors of the liquid crystal display device;

FIG. 6 is an enlarged perspective view of major components of a diffuser, a holder, and a positioning member on the connector;

FIG. 7 is a partial plan view of the diffuser illustrating a light reflectance distribution and a fitted state of the positioning member;

FIG. 8 is an enlarged plan view illustrating a general configuration of a part of a surface of the diffuser facing the hot cathode tube;

FIG. 9 is a graph schematically showing a change in light reflectance along line A-A of FIG. 7 in the short side direction of the diffuser;

FIG. 10 is a graph schematically showing a change in light reflectance along line B-B of FIG. 7 in the long side direction of the diffuser;

FIG. 11 is a graph schematically showing a brightness distribution of the hot cathode tube with respect to the short side direction of the diffuser when the diffuser is disposed in a normal position and not disposed in a normal position with respect to the hot cathode tube;

FIG. 12 is a graph schematically showing a brightness distribution of exited light with respect to the short side direction of the diffuser when the diffuser is disposed in the normal position and not disposed in the normal position with respect to the hot cathode tube;

FIG. 13 is a cross sectional view of the liquid crystal display device according to a first modification of the first embodiment taken along the long side direction in which positioning members are provided on the holder;

FIG. 14 is an enlarged perspective view of a part of the diffuser, the holder, and the positioning members on the connector according to the first modification of the first embodiment;

FIG. 15 is a cross sectional view of the liquid crystal display device according to a second modification of the first embodiment taken along the long side direction in which the light source positioning member and the optical member positioning member are fitted to each other via a connecting member;

FIG. 16 is a cross sectional view of the liquid crystal display device according to a third modification of the first embodiment taken along the long side direction, where the light source positioning member is provided on the chassis;

FIG. 17 is an enlarged perspective view of a part of the diffuser, the holder, the connector, and the positioning member on the chassis according to the third modification of the first embodiment;

FIG. 18 is a graph schematically showing a change in light reflectance along the short side direction of the diffuser according to a fourth modification of the first embodiment;

FIG. 19 is a graph schematically showing a change in light reflectance along the short side direction of the diffuser according to a fifth modification of the first embodiment;

FIG. 20 is an exploded perspective view showing a schematic configuration of the liquid crystal display device according to a second embodiment including two hot cathode tubes;

FIG. 21 is a plan view showing a layout of the hot cathode tubes, the chassis, the support members, and the connectors of the liquid crystal display device according to the second embodiment;

FIG. 22 is a graph schematically showing a change in light reflectance along the short side direction of the diffuser according to the second embodiment;

FIG. 23 is an exploded perspective view showing a schematic configuration of the liquid crystal display device according to a third embodiment in which cold cathode tubes are used;

FIG. 24 is a side view of apart of the liquid crystal display device seen from the short side according to the third embodiment;

FIG. 25 is a cross sectional view of the liquid crystal display device according to the third embodiment taken along the long side direction;

FIG. 26 is a graph schematically showing a change in light reflectance along the short side direction of the diffuser according to the third embodiment;

FIG. 27 is an exploded perspective view showing a schematic configuration of the liquid crystal display device according to the fourth embodiment in which LEDs are used;

FIG. 28 is a cross sectional view of the liquid crystal display device according to the fourth embodiment taken along the long side direction;

FIG. 29 is a graph schematically showing a change in light shielding rate along the short side direction of the optical member according to another embodiment; and

FIG. 30 is a graph schematically showing a change in light transmittance along the short side direction of the optical member according to another embodiment.

### BEST MODE FOR CARRYING OUT THE INVENTION

### First Embodiment

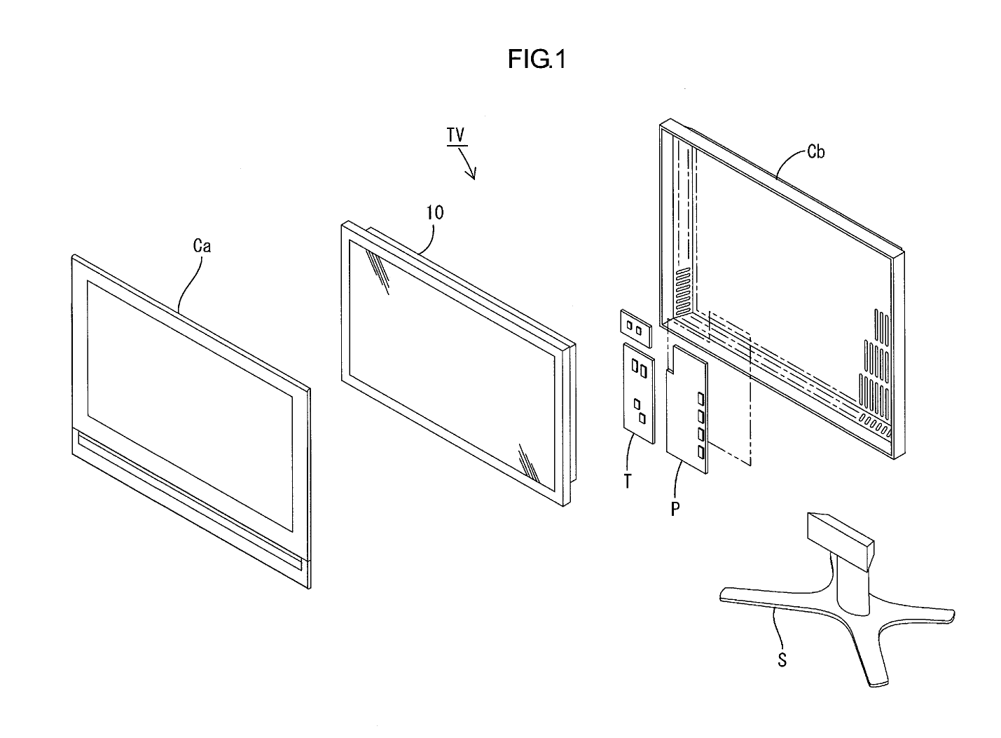

A first embodiment of the present invention will be described with reference to FIGS. 1 to 12. First, the configuration of a television receiver TV including a liquid crystal display device 10 will be described.

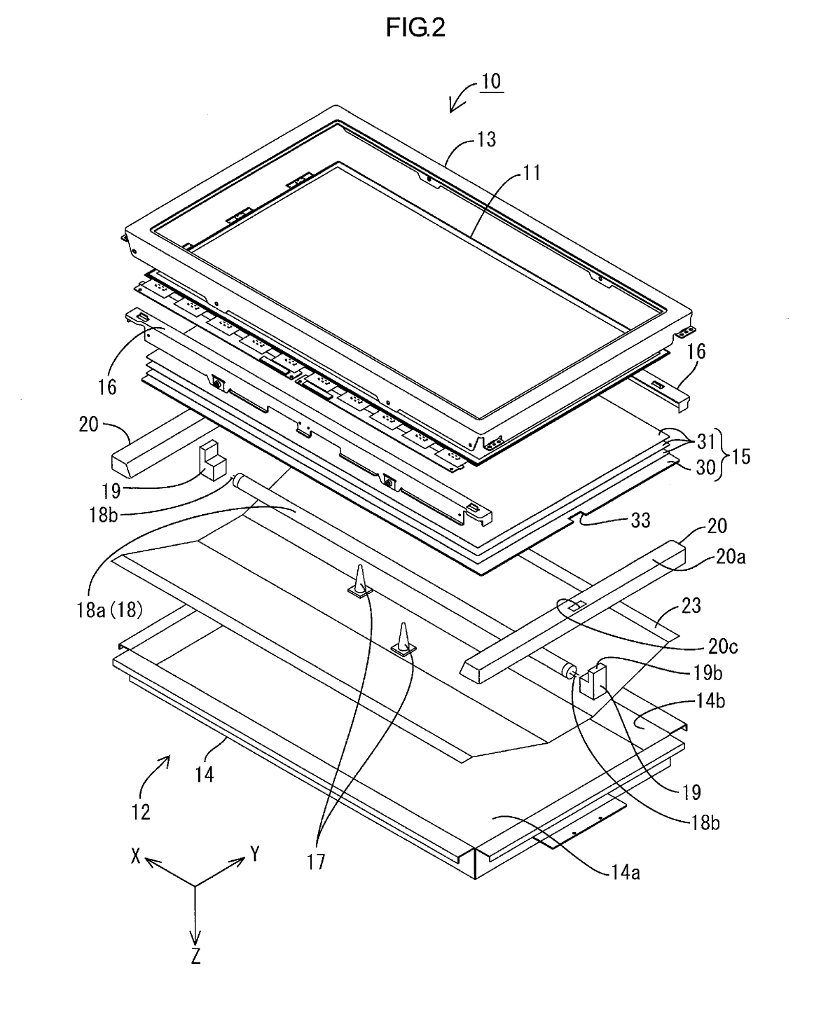

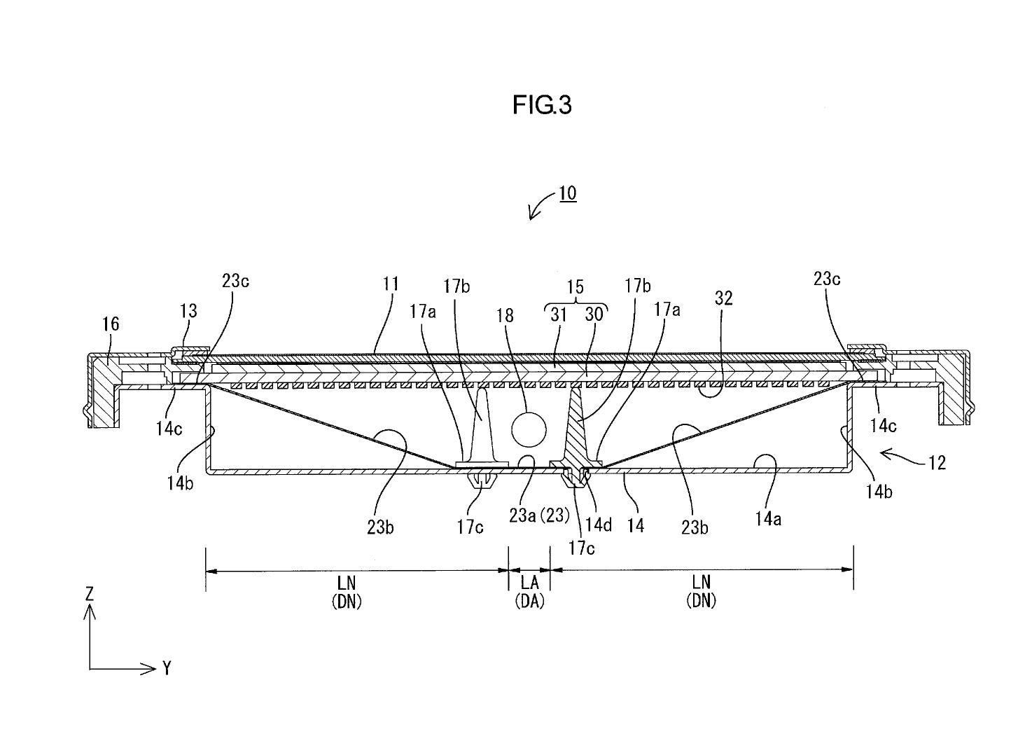

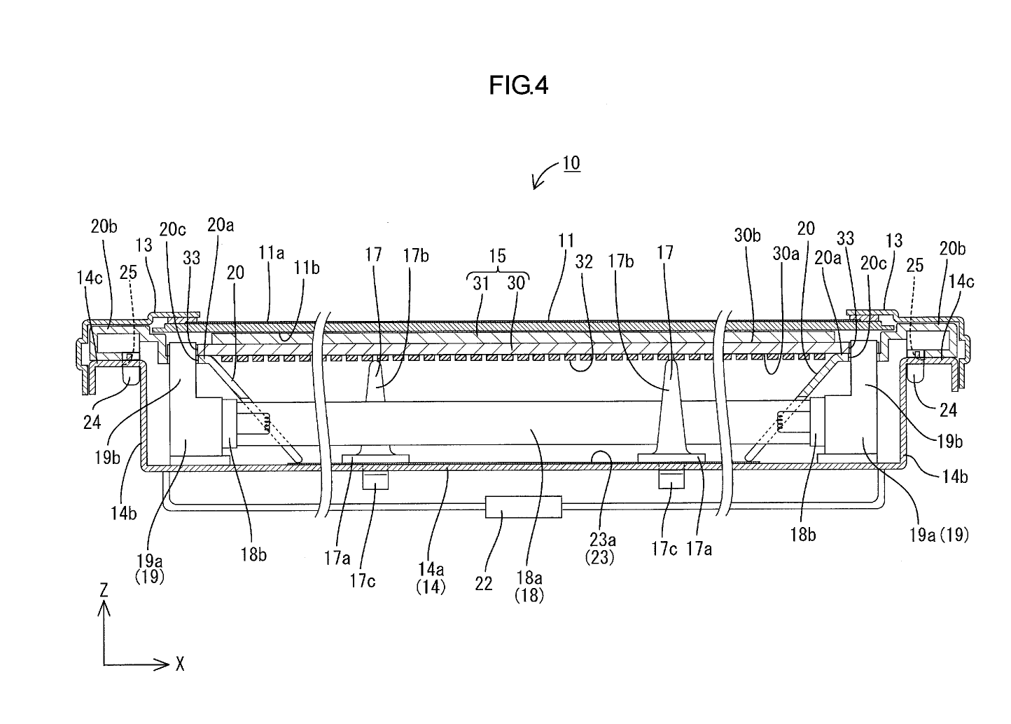

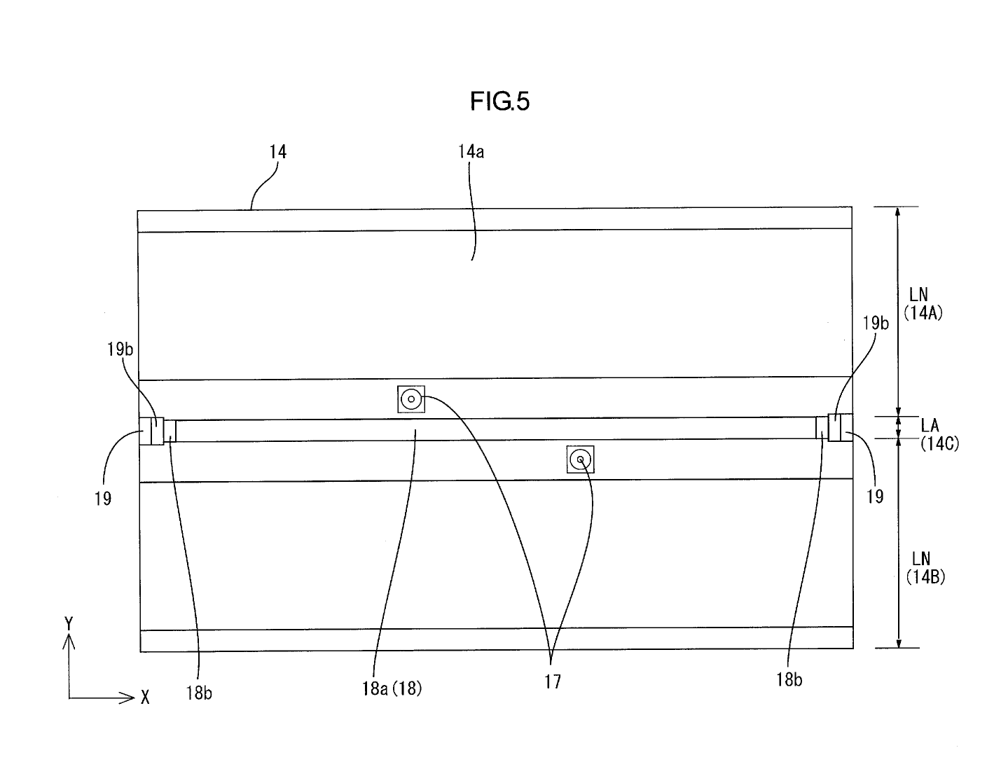

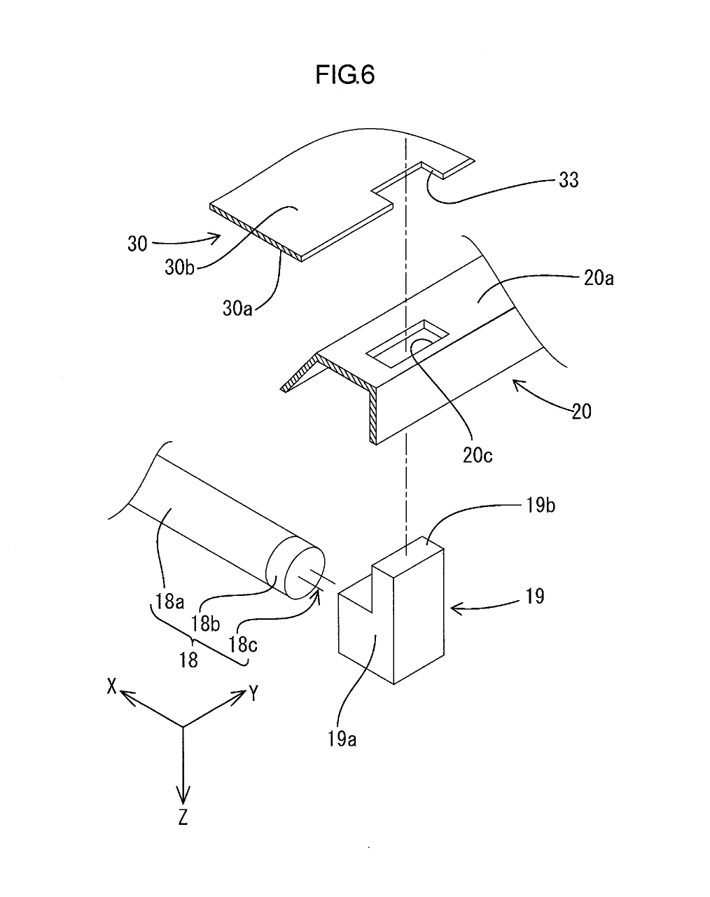

FIG. 1 is an exploded perspective view showing a schematic configuration of the television receiver according to the present embodiment. FIG. 2 is an exploded perspective view showing a schematic configuration of the liquid crystal display device of the television receiver of FIG. 1. FIG. 3 is a cross section view of the liquid crystal display device of FIG. 2 taken along a short side direction thereof. FIG. 4 is a cross section view of the liquid crystal display device of FIG. 2 taken along a long side direction thereof. FIG. 5 is a plan view showing a layout of a hot cathode tube, a chassis, support members, and connectors of the liquid crystal display device of FIG. 2. FIG. 6 is an enlarged perspective view of major components of a diffuser, a lamp holder, and a positioning member on the connector of the liquid crystal display device of FIG. 2. In the following description, the top of FIGS. 3 and 4 will be referred to as a “front side” (optical member side) and the bottom of FIGS. 3 and 4 will be referred to as a “back side” (chassis side). A top-bottom direction orthogonal to the plane of the optical member will be referred to as a “Z-axis direction”. A long side direction of the chassis of FIG. 5 will be referred to as an “X-axis direction”, and a short side direction of the chassis will be referred to as a “Y-axis direction”.

As illustrated in FIG. 1, the television receiver TV according to the present embodiment includes the liquid crystal display device 10; front and rear cabinets Ca and Cb that house the liquid crystal display device 10 in a sandwiching manner; a power source P; a tuner T; and a stand S. The liquid crystal display device (display device) 10 is horizontally-long square (rectangular) as a whole and housed in an upright manner. As illustrated in FIG. 2, the liquid crystal display device 10 includes a liquid crystal panel 11 serving as a display panel, and a backlight unit (lighting device) 12 serving as an external light source. The liquid crystal panel 11 and the backlight unit 12 are integrally held by a frame-shaped bezel 13 and the like. In the present embodiment, the liquid crystal display having a screen size of 32 inches and an aspect ratio of 16:9 is used as an example. More specifically, the screen has a horizontal dimension (dimension in the X-axis direction) of, for example, about 698 mm and a vertical dimension (dimension in the Y-axis direction) of, for example, about 392 mm.

The liquid crystal panel 11 and the backlight unit 12 of the liquid crystal display device 10 will be described next (see FIGS. 2 to 4).

The liquid crystal panel (display panel) 11 includes a pair of glass substrates attached to each other with a predetermined gap in which liquid crystal is contained. One of the glass substrates is provided with switching components (such as TFTs) connected to source wiring and gate wiring that are orthogonal to each other, pixel electrodes connected to the switching components, an alignment film, or the like. The other glass substrate is provided with color filters including colored portions of, for example, R (red), G (green), and B (blue) that are disposed in predetermined arrangements, counter electrodes, an alignment film, or the like. On the outer sides of the substrates, polarizing plates 11a and 11b are disposed (see FIGS. 3 and 4).

As illustrated in FIG. 2, the backlight unit 12 includes a chassis 14 having an opening 14b on the side of a light emitting surface (facing the liquid crystal panel 11) and having a substantially box shape, a group of optical members 15 (including a diffuser (light diffuser member) 30 and a plurality of optical sheets 31 disposed between the diffuser 30 and the liquid crystal panel 11) covering the opening 14b of the chassis 14; frames 16 disposed along the long sides of the chassis 14 and holding the long side edges of the group of optical members 15 onto the chassis 14; and support members 17 supporting substantially a middle portion of the optical members 15 in the short side direction. The chassis 14 houses a hot cathode tube 18 as a light source (linear light source); relay connectors 19 for relaying electrical connection at the end portions of the hot cathode tube 18; and holders 20 (corresponding to a covering portion) covering the end portions of the hot cathode tube 18 and the relay connectors 19 collectively. In the backlight unit 12, a light emitting side may refer to a side facing the optical members 15 with respect to the hot cathode tube 18.

As illustrated in FIGS. 3 and 4, the chassis 14, which is made of a metal, includes a rectangular bottom plate 14a; side plates 14b rising from the end portions on the sides of the bottom plate 14a toward the front side; and receiving plates 14c extending outward from the rising end portions of the side plates 14b. Thus, the chassis 14 has a substantially shallow box shape as a whole. The bottom plate 14a has a rectangular (longitudinal) shape with its long side direction and short side direction aligned with those of the liquid crystal panel 11 and the optical members 15. The size of the bottom plate 14a is substantially the same as those of the liquid crystal panel 11 and the optical members 15 in plan view. In both end portions of the bottom plate 14a in the long side direction, insertion holes for inserting the relay connectors 19 are provided. A pair of the side plates 14b is disposed at both end portions on the long sides of the bottom plate 14a, and another pair is disposed at both end portions on the short sides of the bottom plate 14a. The side plates 14b rise from the bottom plate 14a at a substantially right angle. The receiving plates 14c are formed for the corresponding side plates 14b and have a substantially right bent angle with respect to the side plates 14b. Thus, the receiving plates 14c are parallel with the bottom plate 14a. On the receiving plates 14c, the outer end portions of the reflective sheet 23 and the optical members 15 are placed. Therefore, it is possible to receive reflective sheet 23 and the optical members 15 from the back side. As illustrated in FIG. 3, attaching holes 14d are provided in the receiving plates 14c. Therefore, the bezel 13, the frame 16, and the chassis 14 and the like can be integrated by using screws, for example.

The reflective sheet 23 may be made of a synthetic resin (such as foamed PET) and include a white surface for high light reflectance. As illustrated in FIG. 2, the reflective sheet 23 is disposed on an inner surface of the chassis 14 (facing the hot cathode tube 18) in such a manner as to cover substantially the entire areas of the inner surface. The reflective sheet 23 is configured to reflect light emitted from the hot cathode tube 18 toward the optical members 15. The reflective sheet 23 has, as a whole, a generally rectangular (longitudinal) shape with its long side direction and short side direction aligned with those of the chassis 14. The reflective sheet 23 is symmetrical with respect to the short side direction. The reflective sheet 23 includes a bottom portion 23a disposed along the bottom plate 14a of the chassis 14; a pair of rising portions 23b rising from the end portions of the bottom portion 23a toward the front side (light emitting side); and a pair of extending portions 23c extending outward from the rising-end portions (opposite to the bottom portion 23a) of the rising portions 20b. The bottom portion 23a and a pair of the rising portions 23b of the reflective sheet 23 may have substantially the same size as the bottom plate 14a of the chassis 14 has a size as the bottom plate 14a of the chassis 14 in plan view, thus overlapping with the bottom plate 14a in plan view. In other words, the bottom plate 14a of the chassis 14 has a size as large as to cover all of areas of the bottom portion 23a and the pair of the rising portions 23b of the reflective sheet 23 in plan view.

As illustrated in FIG. 4, the optical members 15 have a horizontally-long square (rectangular) shape in plan view, similarly to the liquid crystal panel 11 and the chassis 14, and is disposed between the liquid crystal panel 11 and the hot cathode tube 18. The optical members 15 include the diffuser 30 disposed on the back side (facing the hot cathode tube 18; opposite to the light emitting side), and the optical sheet 31 disposed on the front side (facing the liquid crystal panel 11; the light emitting side). The diffuser 30 includes a substantially transparent base substrate made of a resin and having a predetermined thickness in which a number of diffusing particles are dispersed. The diffuser 30 has a function of dispersing transmitted light and, as will be described in detail below, also has a function of reflecting light emitted from the hot cathode tube 18. The optical sheet 31 has a smaller sheet thickness than the diffuser 30 and includes three layers. Specifically, the optical sheet 31 includes a diffuser sheet, a lens sheet, and a reflection-type polarizing sheet laminated in this order from the side of the diffuser 30 (back side).

The support members 17 may be made of a synthetic resin (such as polycarbonate), and the entire surface of the support members 17 may be in a white-based color for high light reflectance. As illustrated in FIGS. 3 and 4, the support members 17 include a body portion 17a extending along the bottom plate 14a of the chassis 14; a substantially conical support portion 17b protruding from the body portion 17a toward the front side (toward the optical members 15); and an stopper portion 17c protruding from the body portion 17a toward the back side (toward the bottom plate 14a of the chassis 14). The stopper portion 17c includes a pair of elastic locking parts which are passed through an attaching hole 14d formed in the chassis 14. The elastic locking parts are elastically engaged on the back-side edge of the attaching holes 14d, such that the support members 17 can be retained in an engaged state with respect to the chassis 14. As illustrated in FIG. 5, a pair of the support members 17 is disposed in substantially the middle portion of the chassis 14 in the long side direction at positions diagonally across the hot cathode tube 18 from each other. Thus, the middle portion of the optical members 15 in the long side direction, which tends to be easily warped, bent, or otherwise deformed by thermal expansion or contraction, can be appropriately supported by the support members 17.

As illustrated in FIGS. 3 and 4, the hot cathode tube 18 has a tubular (linear) shape as a whole and includes a hollow glass tube 18a and a pair of electrodes 18b disposed at the end portions of the glass tube 18a. The glass tube 18a contains mercury and a rare gas, and the inner walls of the glass tube 18a are coated with a fluorescent material. Each of the electrodes 18b includes a filament and a pair of terminal pins 18c (see FIG. 6) connected to the end portions of the filament. The hot cathode tube 18 is disposed between the diffuser 30 and the bottom plate 14a (reflective sheet 23) of the chassis 14, which means the hot cathode tube 18 is disposed at a position closer to the bottom plate 14a of the chassis 14 than to the diffuser 30. The hot cathode tube 18 may have an outer diameter of, for example, about 15.5 mm, which is greater than the outer diameter of a cold cathode tube (for example, about 4 mm).

As illustrated in FIG. 5, a pair of the relay connectors 19 connected to the hot cathode tube 18 is disposed at the end portions of the chassis 14 in the long side direction in a middle portion 14C, which will be described later. The relay connectors 19 have a function of relaying electrical connection between the hot cathode tube 18 and an inverter substrate 22. As illustrated in FIG. 4, the relay connectors 19 include a body portion 19a made of a synthetic resin, and a connector-side electrode portion (not illustrated) housed in the body portion 19a. One end of the connector-side electrode portion (not illustrated) is connected to the terminal pins 18c of the hot cathode tube 18, and the other end is connected to the inverter substrate 22, which is mounted on an outer surface side (back surface side) of the bottom plate 14a of the chassis 14. The connector-side electrode portion (not illustrated) and the terminal pins 18c of the hot cathode tube 18 are electrically connected to each other, such that the hot cathode tube 18 can be supplied with drive power from the inverter substrate 22, and the tube current value of the hot cathode tube 18, i.e., its brightness (lighting state), can be controlled by the inverter substrate 22.

As illustrated in FIG. 5, the hot cathode tube 18 has the above structure, and only a single hot cathode tube 18 is housed in the chassis 14 with its length direction (axial direction) aligned with the long side direction of the chassis 14. The hot cathode tube 18 is located substantially at the center of the chassis 14 in the short side direction. Specifically, when the bottom plate 14a (facing the optical members 15 and the hot cathode tube 18) of the chassis 14 is divided into a first end portion 14A, a second end portion 14B disposed on the side opposite to the first end portion 14A, and a middle portion 14C between the first and second end portions 14A and 14B in the short side direction (Y-axis direction), the hot cathode tube 18 is disposed in the middle portion 14C, where a light source disposed area LA is formed. On the other hand, the hot cathode tube 18 is not disposed in the first end portion 14A and the second end portion 14B of the bottom plate 14a, where light source non-disposed areas LN are formed. Thus, the hot cathode tube 18 is disposed exclusively in the middle portion 14C of the bottom plate 14a of the chassis 14 in the short side direction, where the light source disposed area LA is formed. The area of the light source disposed area LA (length dimension in the Y-axis direction) is smaller than that of the light source non-disposed areas LN (length dimension in the Y-axis direction). The ratio of the area of the light source disposed area LA (length dimension in the Y-axis direction) to the area of the entire screen (vertical dimension (short side dimension) of the screen) may be on the order of 4%, for example. A pair of the light source non-disposed areas LN may have substantially the same-size areas. The hot cathode tube 18 has a length dimension substantially the same as the horizontal dimension (long side dimension) of the screen.

The holders 20 covering the end portions of the hot cathode tube 18 and the relay connectors 19 are made of a white synthetic resin. As illustrated in FIG. 2, the holders 20 have a substantially box-like slender shape extending along the short side direction of the chassis 14. As illustrated in FIG. 4, the holders 20 include plate holding portions 20a having a step-like surface on the front side on which the optical members 15 and the liquid crystal panel 11 can be placed at different levels. The holders 20 also include connecting portions 20b at end portions extending outward from the plate holding portions 20a, the connecting portions 20b partially overlapping with the receiving plates 14c of the chassis 14 in the short side direction.

The holders 20 form side walls of the backlight unit 12 together with the side plates 14b of the chassis 14. As illustrated in FIG. 4, insertion pins 24 protrude from a surface of the holders 20 that faces the receiving plates 14c of the chassis 14. The insertion pins 24 are inserted into insertion holes 25 formed in the receiving plates 14c facing the surface, such that the holders 20 can be attached to the chassis 14.

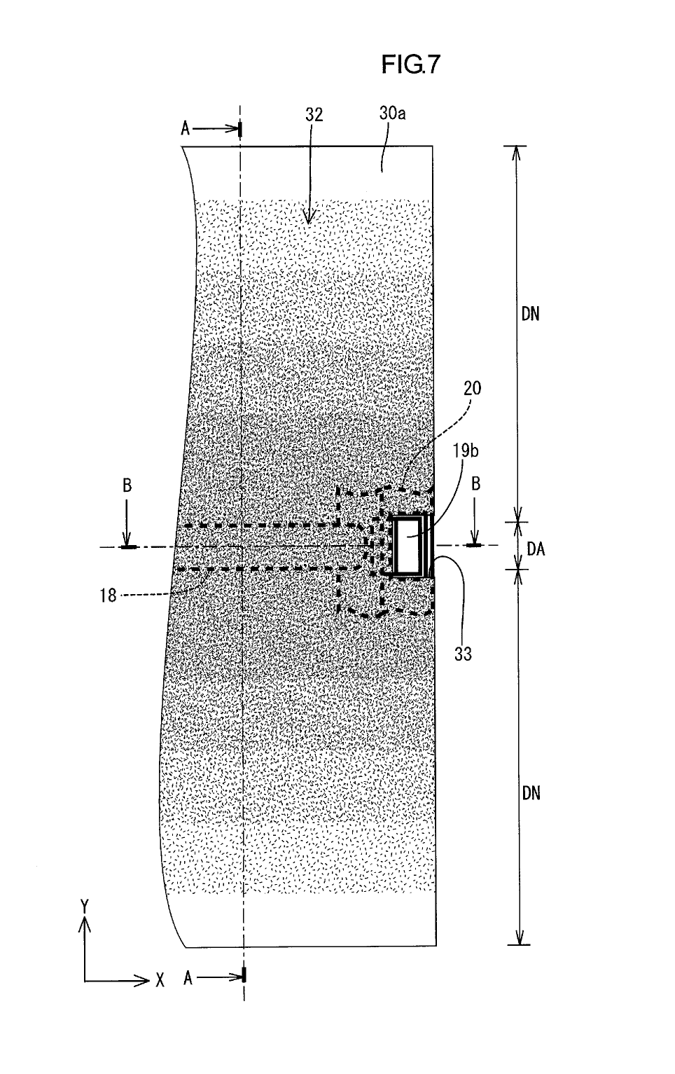

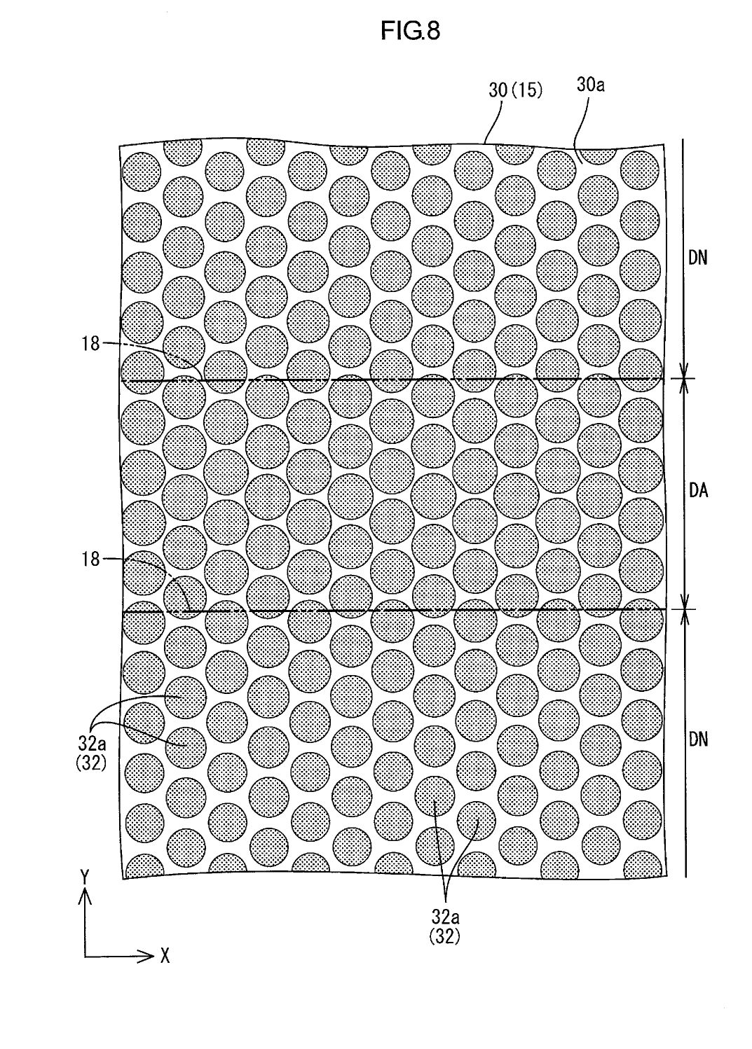

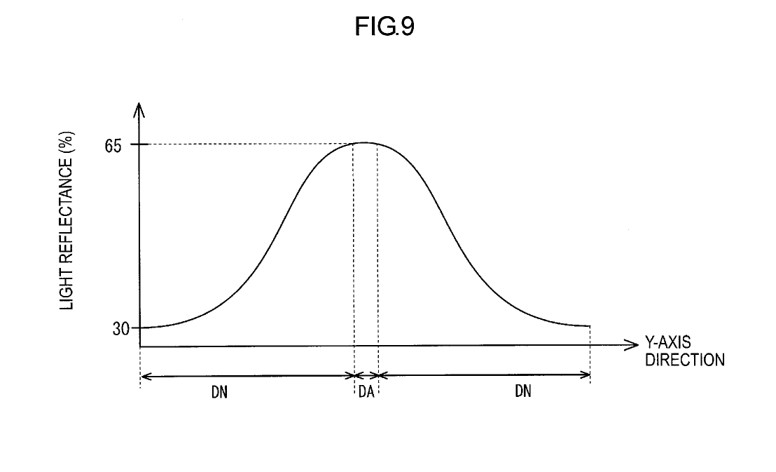

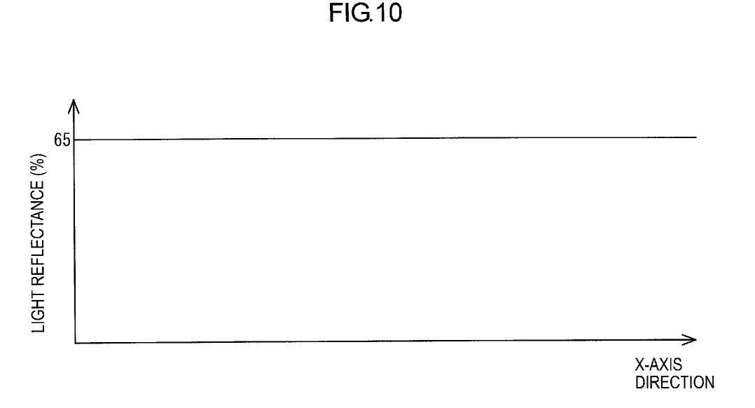

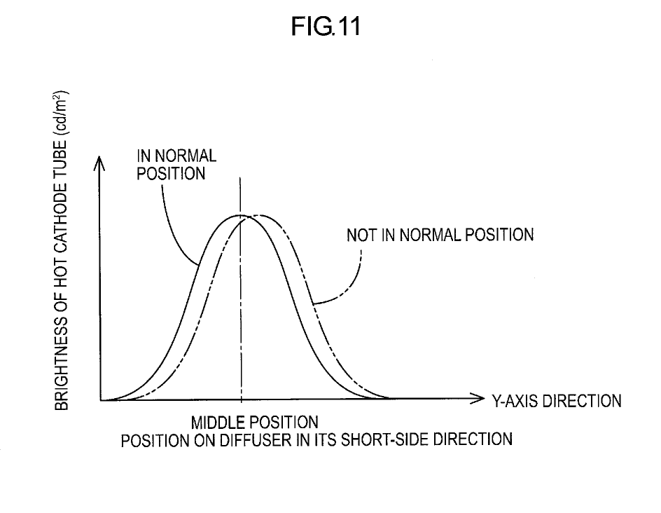

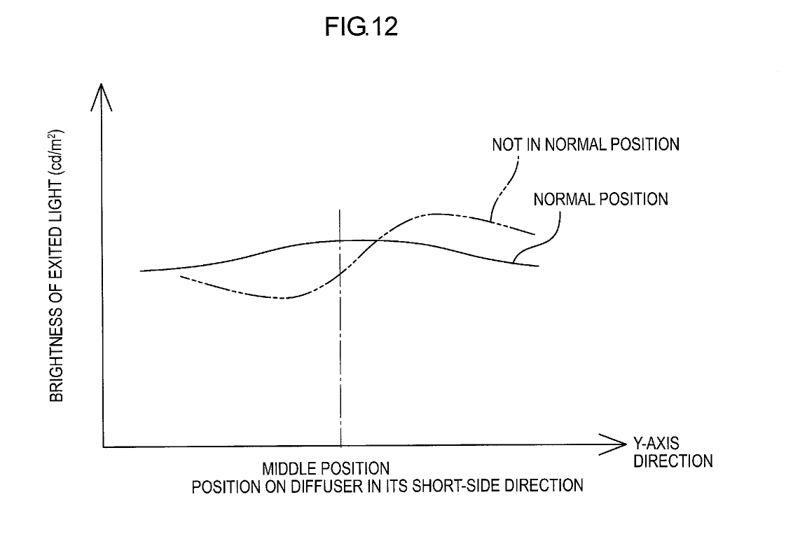

Next, the light reflecting function of the diffuser 30 will be described in detail. FIG. 7 is a partial plan view of the diffuser illustrating a light reflectance distribution and a fitted state of positioning members. FIG. 8 is an enlarged plan view of a major component of the diffuser of FIG. 7, showing a schematic configuration of a light reflecting portion on the surface facing the hot cathode tube. FIG. 9 is a graph showing a change in light reflectance along line A-A of the diffuser of FIG. 7 in the short side direction. FIG. 10 is a graph showing a change in light reflectance along line B-B of the diffuser of FIG. 7 in the long side direction. FIG. 11 is a graph showing a brightness distribution of the hot cathode tube with respect to the short side direction of the diffuser when the diffuser is disposed at a normal position and not disposed at the normal position with respect to the hot cathode tube. FIG. 12 is a graph showing a brightness distribution of the emitted light with respect to the short side direction of the diffuser when the diffuser is disposed at the normal position and not disposed at the normal position with respect to the hot cathode tube. In FIGS. 9 to 12, the long side direction of the diffuser (the display screen in FIG. 12) corresponds to the X-axis direction, the short side direction corresponds to the Y-axis direction, and the direction orthogonal to the diffuser corresponds to the Z-axis direction. In FIG. 9, the horizontal axis corresponds to the Y-axis direction (short side direction), and the graph plots light reflectance along the Y-axis direction from the bottom end to the top end of FIG. 7. Similarly, in FIG. 10, the horizontal axis corresponds to the X-axis direction (long side direction), and the graph plots light reflectance along the X-axis direction from the left end portion to the right end portion of FIG. 7. In FIG. 11, the vertical axis indicates the brightness of light irradiated from the hot cathode tube onto the diffuser, and the horizontal axis corresponds to the Y-axis direction (short side direction). The graph of FIG. 11 plots the brightness distribution of the hot cathode tube along the Y-axis direction from the bottom end portion to the top end portion of FIG. 7. Further, in FIG. 12, the vertical axis indicates the brightness of the light emitted from the diffuser, and the horizontal axis corresponds to the Y-axis direction (short side direction). The graph of FIG. 12 plots the brightness distribution of the emitted light between the bottom end portion and the upper end portion of FIG. 7.

The diffuser 30 includes a base substrate made of a substantially transparent synthetic resin (such as polystyrene) in which a predetermined amount of diffusing particle that diffuses light is dispersed. The diffuser 30 has substantially uniform light transmittance and light reflectance throughout the substrate. Preferably, the base substrate of the diffuser 30 (excluding a light reflecting portion 32 which will be described later) may have a light transmittance of about 70% and a light reflectance of about 30%. The diffuser 30 includes a surface (hereafter referred to as a “first surface 30a”) facing the hot cathode tube 18 and a surface (hereafter referred to as a “second surface 30b”) disposed on the side opposite to the first surface 30a and facing the liquid crystal panel 11 (see FIG. 4). The first surface 30a serves as a light incidence plane into which the light from the hot cathode tube 18 enters. The second surface 30b serves as a light emitting plane via which light (illumination light) is emitted toward the liquid crystal panel 11.

On the first surface 30a constituting the light incidence plane of the diffuser 30, a light reflecting portion 32 having a white dot pattern is formed, as illustrated in FIGS. 7 and 8. Specifically, the light reflecting portion 32 includes a plurality of dots 32a which are circular in plan view and which are arranged in a zig-zag (staggered or alternating) manner. The dot pattern of the light reflecting portion 32 is formed by printing a paste containing a metal oxide on the surface of the diffuser 30. Preferable printing means for this purpose are screen printing, inkjet printing, and the like. The light reflecting portion 32 may have a light reflectance of about 75%. This is larger than the light reflectance of the diffuser 30 itself in the plane thereof, which is about 30%. According to the present embodiment, the light reflectance of the various materials is based on average light reflectance measured in a measurement diameter by using CM-3700d from Konica Minolta, Inc., with LAV (measurement diameter φ25.4 mm). The light reflectance of the light reflecting portion 32 itself may be measured by forming the light reflecting portion 32 on an entire surface of a glass substrate and measuring the formed surface by using the above measuring apparatus.

The diffuser 30 has a long side direction (X-axis direction) and a short side direction (Y-axis direction). By varying the dot pattern of the light reflecting portion 32, the light reflectance on the first surface 30a of the diffuser 30 facing the hot cathode tube 18 can be varied along the short side direction, as illustrated in FIG. 9. Specifically, as illustrated in FIG. 7, the diffuser 30 is configured such that, on the first surface 30a as a whole, the light reflectance in a portion overlapping with the hot cathode tube 18 (hereafter referred to as a “light source overlapping portion DA”) is greater than the light reflectance in a portion not overlapping with the hot cathode tube (hereafter referred to as a “light source non-overlapping portion DN”). The light reflectance on the first surface 30a of the diffuser 30 is varied little and remains almost constant along the long side direction, as illustrated in FIG. 10.

The distribution of light reflectance of the diffuser 30 will be described in detail. As illustrated in FIGS. 7, 9, and 10, the light reflectance of the diffuser 30 is continuously decreased in a direction away from the hot cathode tube 18 along the short side direction (Y-axis direction) and is continuously increased in a direction toward the hot cathode tube 18, such that the light reflectance exhibits a bell-shaped curve similar to the normal distribution. Specifically, the light reflectance of the diffuser 30 is maximum at its middle position (corresponding to the center of the hot cathode tube 18) in the short side direction and minimum at its end positions in the short side direction. The maximum value of light reflectance may be about 65%, for example, while the minimum value may be about 30%, for example, which may be the same as the light reflectance of the diffuser 30 itself. Thus, at the end positions of the diffuser 30 in the short side direction, the light reflecting portion 32 may be present only in a small amount or almost nonexistent.

The above light reflectance distribution is obtained by forming the light reflecting portion 32 as follows. For example, the area of each of the dots 32a constituting the light reflecting portion 32 is maximized at the middle position of the diffuser 30 in the short side direction, i.e., at the middle position of the hot cathode tube 18. The further the distance from the middle position is, the smaller area the dots have. The area is minimized at the end positions of the diffuser 30 in the short side direction. Namely, the area of the dots 32a is decreased as the distance from the center of the hot cathode tube 18 increases. In this way, the diffuser 30 as a whole can provide a gradual brightness distribution of illumination light, which enables the backlight unit 12 as a whole to provide a gradual brightness distribution of the illumination light. Preferably, the light reflectance may be adjusted by varying the intervals between the dots 32a while each of the area of each of the dots 32a of the light reflecting portion 32 is maintained constant.

The diffuser 30 according to the present embodiment may have optical characteristics including anisotropy in its plane, corresponding to the hot cathode tube 18 eccentrically-located within the chassis 14. Namely, while the light reflectance of the diffuser 30 is substantially constant in the long side direction (X-axis direction, or the axial direction of the hot cathode tube 18; see FIG. 10), the light reflectance is varied in the short side direction (Y-axis direction, which is along the plane of the diffuser 30 and orthogonal to the axial direction of the hot cathode tube 18; see FIG. 9). The distribution of the light reflectance of the diffuser 30 is such that the reflectance is maximum at the middle portion in the short side direction overlapping with the hot cathode tube 18 and is gradually decreased toward the ends in the short side direction, i.e., away from the hot cathode tube 18. In the diffuser 30 with such optical design, it is important to maintain a constant positional relationship with the hot cathode tube 18, particularly with respect to the Y-axis direction along which the light reflectance is varied. Particularly, in the present embodiment, the hot cathode tube 18, which is a high-brightness light source compared to a cold cathode tube is used and only a single hot cathode tube 18 is eccentrically disposed in the chassis 14. Thus, even a slight displacement of the diffuser 30 and the hot cathode tube 18 in the Y-axis direction significantly affects the brightness distribution of the light emitted from the diffuser 30. In the following, a detailed description will be given of how the brightness distribution of the light emitted from the diffuser is varied in a case where the diffuser 30 and the hot cathode tube 18 are positioned with respect to the Y-axis direction as intended (“normal position”) and in a case where a displacement between the diffuser 30 and the hot cathode tube 18 (“non-normal position”) occurs.

When the hot cathode tube 18 and the diffuser 30 are disposed at the normal position, the peak of brightness of the light with which the diffuser 30 is irradiated by the hot cathode tube 18 corresponds to the middle position of the diffuser 30 in the short side direction, as indicated by a solid line in FIG. 11. On the other hand, when the hot cathode tube 18 and the diffuser 30 are disposed at the non-normal position, the peak of brightness of the light with which the diffuser 30 is irradiated by the hot cathode tube 18 is displaced from the middle position toward one end or the other end of the diffuser 30 in the short side direction, as indicated by a two-dot chain line in FIG. 11. Thus, the brightness distribution of the hot cathode tube 18 is varied between the normal position and the non-normal position. Because the diffuser 30 has the light reflectance distribution as illustrated in FIG. 9, it is expected that the brightness distribution of the light emitted from the diffuser 30 will be as illustrated in FIG. 12. Namely, in the case of the normal position, as indicated by a solid line in FIG. 12, the brightness distribution of the light emitted from the diffuser 30 in the short side direction (Y-axis direction) is gradually curved with the brightness peaking at the middle position in the short side direction. On the other hand, in the case of the non-normal position, as indicated by a two-dot chain line in FIG. 12, the position of brightness peak is displaced from the middle position toward one end or the other end in the short side direction, with an increased difference between highs and lows of brightness throughout the display screen, thus causing uneven brightness.

Thus, in the present embodiment, a pair of the relay connectors 19, which fixes the hot cathode tube 18, and the diffuser 30 of the optical members 15 each are provided with a positioning member. Therefore, the hot cathode tube 18 and the diffuser 30 of the optical members 15 can be positioned at the normal position in the Y-axis direction and uneven brightness can be prevented. Specifically, as illustrated in FIGS. 4 and 6, each of the relay connectors 19 includes a convex portion 19b serving as a light source positioning member protruding from a front-side surface of the body portions 19a. The convex portions 19b are formed in substantially a rectangular parallelepiped and extend from the front-side surface of the body portion 19a closer to the side opposite to the portion connected to the electrodes 18b of the hot cathode tube 18. The convex portions 19b may have a length in the extending direction (Z-axis direction) such that, when the diffuser 30 is disposed on the holders 20, the second surface 30b of the diffuser 30 is flush with an extension-end surface of the convex portions 19b. Corresponding to the convex portions 19b, the diffuser 30 includes a pair of cutout portions 33 serving as an optical member positioning member in the form of cut-outs. Each of the cutout portions 33 is located at substantially the middle position (directly above the convex portion 19b) of the end portion of the diffuser 30 in the long side direction (X-axis direction), as illustrated in FIGS. 2 and 6.

The convex portions 19b of the relay connectors 19 are fitted to the cutout portions 33 and accordingly, displacement of the diffuser 30 with respect to the relay connectors 19 in the Y-axis direction is restricted. Specifically, the convex portions 19b of the relay connectors 19 are abutted on the side surfaces of the cutout portions 33 along the X-axis direction and accordingly, the diffuser 30 is fixed and cannot be displaced in the Y-axis direction. In addition, the convex portions 19b of the relay connectors 19 are abutted on the side surfaces of the cutout portions 33 along the Y-axis direction and accordingly, the displacement of the diffuser 30 in the X-axis direction is restricted. The holders 20 are disposed between the relay connectors 19 and the diffuser 30. The holders 20 include positioning insertion holes 20c at a location corresponding to the fitting area through which the convex portions 19b of the relay connectors 19 can be inserted.

Next, the operation of the above structure according to the present embodiment will be described. When the hot cathode tube 18 is turned on in order to use the liquid crystal display device 10, the light emitted from the hot cathode tube 18 enters into the first surface 30a of the diffuser 30 either directly or indirectly via reflection by the reflective sheet 23, the holders 20, or the like. After passing through the diffuser 30, the light is emitted via the optical sheet 31 toward the liquid crystal panel 11. In the following, the light-reflecting function of the diffuser 30 will be described.

On the first surface 30a of the diffuser 30 into which the light emitted from the hot cathode tube 18 enters, there is formed the light reflecting portion 32 having different light reflectance in different areas in the plane thereof, as illustrated in FIGS. 3 and 7. Thus, the light incidence efficiency can be appropriately controlled on an area-by-area basis. Specifically, in the light source overlapping portion DA of the first surface 30a overlapping with the hot cathode tube 18, there is more direct light from the hot cathode tube 18. Hence, the amount of light there is greater than that in the light source non-overlapping portions DN. Thus, by relatively increasing the light reflectance of the light reflecting portion 32 in the light source overlapping portion DA (see FIGS. 7 and 9), incidence of light into the first surface 30a can be controlled (restricted), while a large amount of light can be reflected back into the chassis 14. On the other hand, in the light source non-overlapping portion DN of the first surface 30a that does not overlap with the hot cathode tube 18, there is less direct light from the hot cathode tube 18. Hence, the amount of light there is smaller than that in the light source overlapping portion DA. Thus, by relatively decreasing the light reflectance of the light reflecting portion 32 in the light source non-overlapping portions DN (see FIGS. 7 and 9), incidence of light on the first surface 30a can be facilitated. In this case, the amount of light in the light source non-overlapping portions DN is compensated as the light reflected into the chassis 14 by the light reflecting portion 32 of the light source overlapping portion DA is taken to the light source non-overlapping portion by the reflective sheet 23 or the like. Accordingly, a sufficient amount of light entering into the light source non-overlapping portion DN can be ensured. Further, with regard to the reflective sheet 23, in the light source non-disposed areas LN of the chassis 14, the space in which light can travel is narrowed by the rising portions 23b of the reflective sheet 23, and the reflected light is angled to be directed toward the center of the screen by the rising portions 23b. In this way, the light source non-disposed areas LN are prevented from being visually recognized as a dark part.

According to the above structure, the brightness distribution of the illumination light exited from the diffuser 30 can be made uniform by controlling the light reflectance on the first surface 30a of the diffuser 30 by the light reflecting portion 32. However, this effect cannot be sufficiently exerted if the diffuser 30 is displaced in the Y-axis direction with respect to the hot cathode tube 18 (see FIG. 11). As a result, uneven brightness occurs (see FIG. 12). Accordingly, in the present embodiment, as described above, the diffuser 30 is held at the proper position (normal position) in the directions (X and Y directions) along the plane of the diffuser 30 with respect to the hot cathode tube 18, such that the effect of the light reflecting portion 32 formed on the diffuser 30 can be exerted as much as possible. In the following, the operation and effect of providing the positioning members to the diffuser 30 and the hot cathode tube 18 in the present embodiment will be described, as well as an assembly procedure.

First, the hot cathode tube 18 and the relay connectors 19 are fixed to the chassis 14 in a mutually connected state. Next, the holders 20 are mounted over the relay connectors 19. Specifically, as illustrated in FIGS. 4 and 6, the convex portions 19b of the relay connectors 19 are inserted into the positioning insertion holes 20c in the plate holding portions 20a of the holders 20. Then, the insertion pins 24 of the holders 20 are inserted into the insertion holes 25 of the chassis 14 located opposite thereto such that the holders 20 can be fixed to the chassis 14. At this time, the convex portions 19b of the relay connectors 19 protrude beyond the plate holding portions 20a. Thereafter, the diffuser 30 is mounted onto the holders 20 such that the convex portions 19b are fitted to the cutout portions 33 having a cut-out shape and provided at both side portions of the diffuser 30, with the surfaces of the diffuser 30 and the holders 20 abutted against each other. As a result, the diffuser 30 is positioned on the relay connectors 19 in the X-axis direction and the Y-axis direction.

More detailed description will be given here. The cutout portions 33 and the convex portions 19b are substantially square when seen from the front side. Thus, when the convex portions 19b are fitted to the cutout portions 33, the side surfaces of the convex portions 19b along the X-axis direction abut against the side surfaces of the cutout portions 33 along the X-axis direction. Therefore, relative displacement of the diffuser 30 and the relay connectors 19 in the Y-axis direction can be restricted. Further, because the cutout portions 33 are provided at two locations on the end portions of the diffuser 30, displacement of the diffuser 30 and the relay connectors 19 in the X-axis direction can also be restricted.

As described above, the convex portions 19b of the relay connectors 19 are caused to be fitted to the cutout portions 33 of the diffuser 30, whereby the hot cathode tube 18 connected to the relay connectors 19 and the diffuser 30 having the light reflecting portion 32 are fixedly positioned at the normal position in the X and Y directions, thus avoiding being positioned at the non-normal position. If the diffuser 30 is displaced from the normal position to the non-normal position in the Y-axis direction with respect to the hot cathode tube 18, uneven brightness is caused in the illumination light exited from the diffuser 30. According to the present embodiment, as the hot cathode tube 18 and the diffuser 30 are fixed at the normal position, uneven brightness can be prevented from occurring.

The cutout portions 33 are provided at the end portions of the diffuser 30 in the long side direction (X-axis direction). Because the end portions are in non-display areas of the display screen, the cutout portions 33 do not affect the brightness of the display screen of the liquid crystal display device 10 at all. Further, because the cutout portions 33 having a cut-out shape are provided at the end portions of the diffuser 30, the cutout portions 33 can be readily formed by press-cutting or the like.

Descriptions have been given of the main effects of the present embodiment. In the following, other operations and effects of the present embodiment will be described.

Because of the use of the hot cathode tube 18 as a light source, higher emission efficiency can be obtained compared to the case where a cold cathode tube or the like is used. Therefore, higher brightness can be obtained.

The optical members 15 are set to have optical properties such that the light reflectance on at least the surface facing the hot cathode tube 18 is varied between the light source overlapping portion DA and the light source non-overlapping portion DN, where the light reflectance is set to become smaller as is farther away from the hot cathode tube 18 across the light source overlapping portion DA and the light source non-overlapping portions DN. In this way, a gradual brightness distribution of the illumination light exited from the optical members 15 can be obtained.

The optical members 15 include the diffuser 30, which is a light diffuser member that diffuses the light from the hot cathode tube 18. On the surface of the diffuser 30 facing the hot cathode tube 18, the light reflecting portion 32 having a light reflectance greater than that of the diffuser 30 is formed. Due to this configuration, the light reflectance of the optical members 15 can be easily controlled by relatively increasing the size of the light reflecting portion 32 formed in an area on the optical members 15 where a greater light reflectance is desired or by relatively reducing the size of the light reflecting portion 32 formed in an area where a smaller light reflectance is desired.

The light reflecting portion 32 includes a number of the light-reflective dots 32a which are substantially point-like in the plane of the optical members 15 on the side facing the hot cathode tube 18 (the first surface 30a of the diffuser 30 according to the present embodiment). In this way, light reflectance can be readily controlled depending on specific aspects of the dots 32a (such as area or distribution density).

The chassis 14 facing the optical members 15 includes a first end portion 14A, a second end portion 14B disposed on the end portion opposite to the first end portion 14A, and a middle portion 14C located between the first end portion 14A and the second end portion 14B. The hot cathode tube 18 is disposed in the middle portion 14C and not in the first end portion 14A or the second end portion 14B. Thus, sufficient brightness can be ensured in the middle portion of the backlight unit 12. In addition, sufficient brightness can be also ensured in the display middle portion of the liquid crystal display device 10 including the backlight unit 12. Accordingly, better visibility can be obtained as compared to a case where the hot cathode tube 18 is disposed only in the end portion such as the first end portion 14A or the second end portion 14B.

Further, the chassis 14 is rectangular in plan view, where the hot cathode tube 18 extends along the long side direction of the chassis 14. The light source disposed area LA and the light source non-disposed areas LN are disposed side by side along the short side direction of the chassis 14. In this way, a linear light source such as the hot cathode tube 18 according to the present embodiment can be suitably used.

In the backlight unit 12 having the above structure, operation, and effects, uneven brightness does not easily occur. Thus, the liquid crystal display device 10 including the backlight unit 12 and the liquid crystal panel 11 can achieve a display with high display quality.

The first embodiment of the present invention has been described above. The present invention is not limited to the foregoing embodiment and may include the following modifications. In the following modifications, members similar to those according to the foregoing embodiment will be designated with similar signs and their illustration in the drawings and description will be omitted.

### First Modification of the First Embodiment

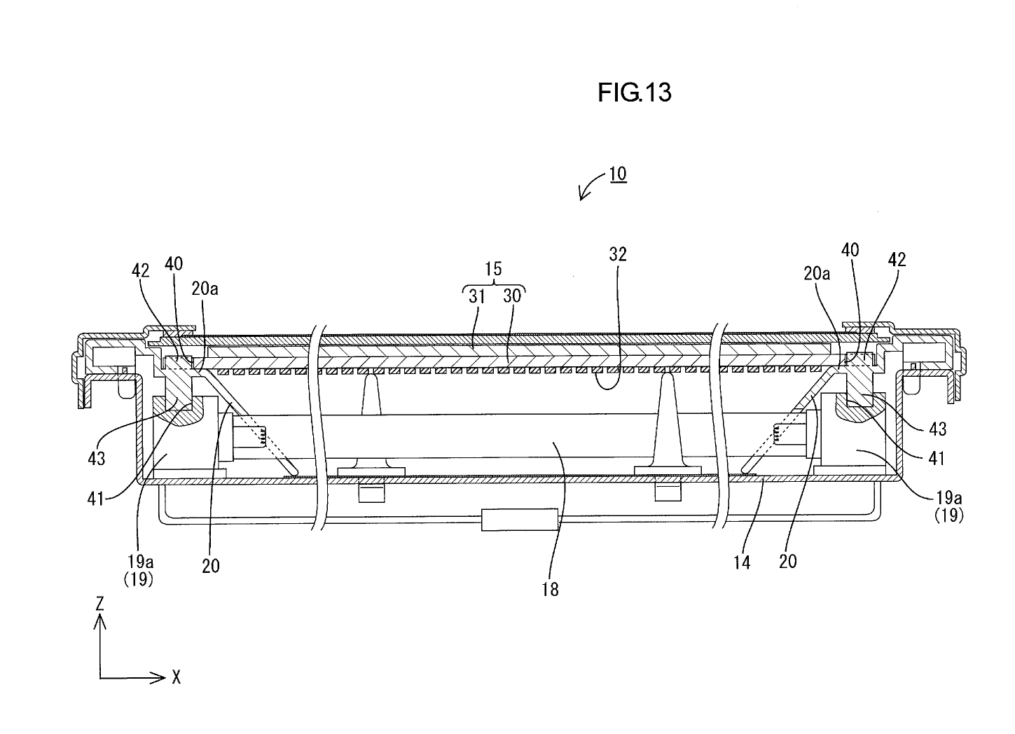

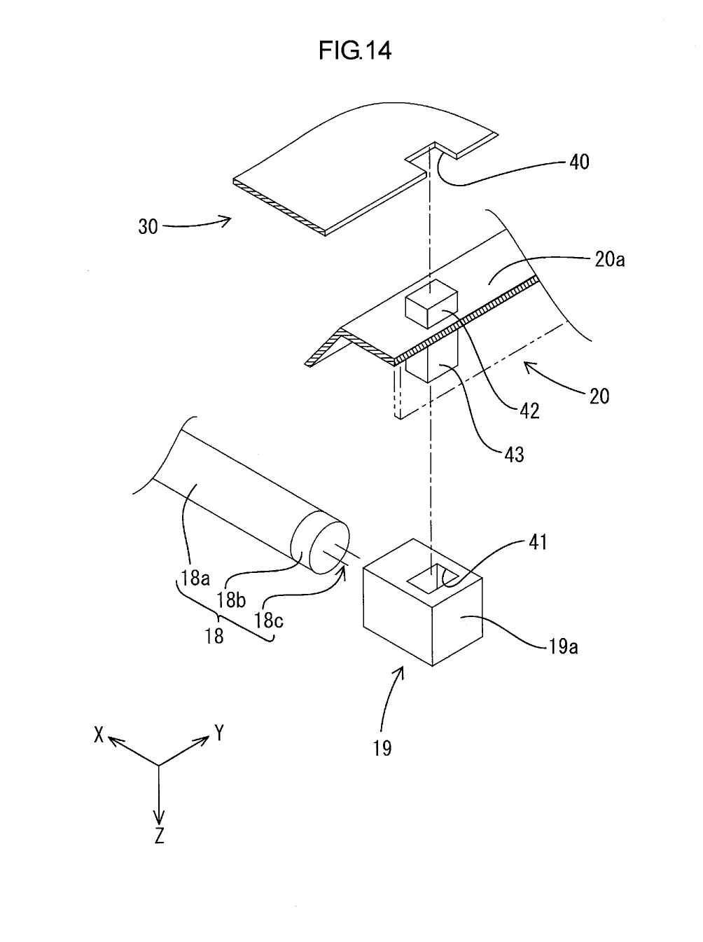

A first modification of the first embodiment will be described with reference to FIGS. 13 and 14. The first modification differs from the first embodiment in the structure of the optical member positioning member and the light source positioning member. FIG. 13 is a cross section view of the liquid crystal display device according to the present modification taken along the long side direction, illustrating an example in which the optical member positioning member and the light source positioning member are disposed on the holder. FIG. 14 is an enlarged perspective view of major components in a positioning area of FIG. 13.

As illustrated in FIGS. 13 and 14, at a middle position of the plate holding portions 20a of the holders 20 in the Y-axis direction, a diffuser-side convex portion 42 protrudes toward the front side in the Z-axis direction. On the opposite side, a connector-side convex portion 43 having a similar shape protrudes toward the back side in the Z-axis direction. The diffuser 30 has a diffuser-side cutout portion 40 at substantially the center of the end portions along the short side. The diffuser-side cutout portion 40 has a cut-out shape, corresponds to the optical member positioning member, and can be fitted to the diffuser-side convex portion 42 of the holders 20. Further, the relay connectors 19 include a substantially box-shaped body portion 19a and a connector-side recess 41 having a concave shape in the upper surface of the body portion 19a that faces the diffuser 30. The connector-side recess 41 can be fitted to the connector-side convex portion 43 of the holders 20.

Next, an assembly procedure of the present modification with the above structure will be described. First, the connector-side convex portions 43 of the holders 20 is fitted to the connector-side recesses 41 of the relay connectors 19 fixed on the chassis 14. In this way, the holders 20 are positioned with respect to the relay connectors 19 and the hot cathode tube 18. Then, fix the holders 20 to the chassis 14 and mount the diffuser 30 onto the fixed holders 20. Specifically, by fitting the diffuser-side cutout portion 40 of the diffuser 30 to the diffuser-side convex portions 42 of the holders 20, the diffuser 30 is positioned with respect to the holders 20. Thus, the relay connectors 19 and the diffuser 30 are positioned via the holders 20 in the Y-axis direction. In this way, the hot cathode tube 18 and the diffuser 30 fixed to the relay connectors 19 are positioned at the normal position in the Y-axis direction, thereby preventing uneven brightness from occurring.

### Second Modification of the First Embodiment

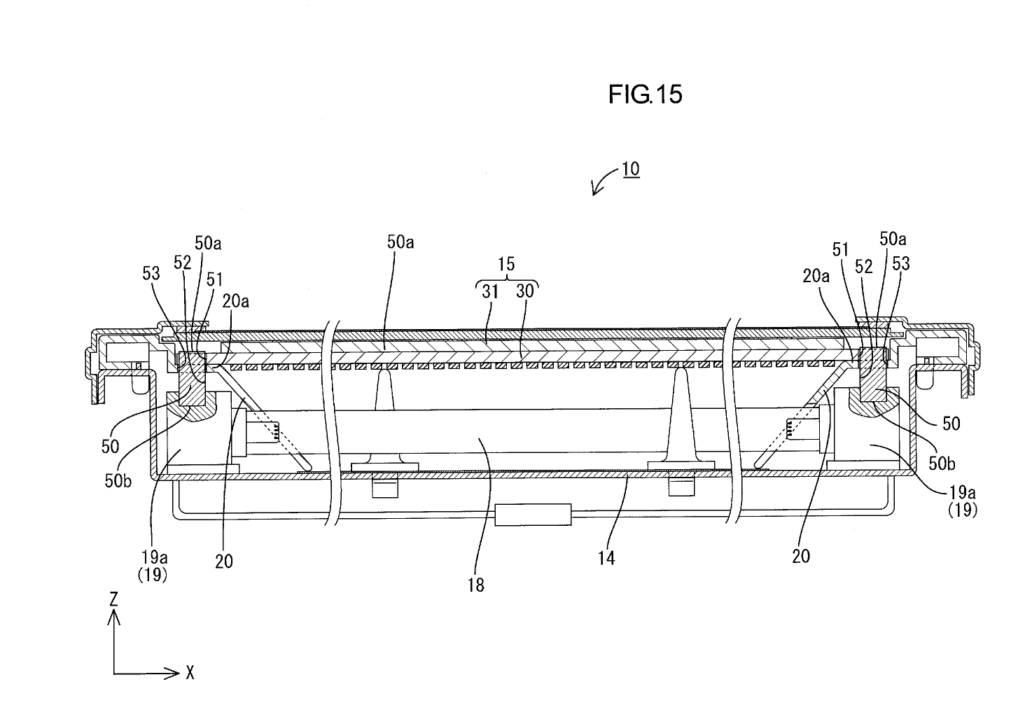

The second modification of the first embodiment will be described with reference to FIG. 15. The second modification includes a connecting member as a separate component from the holders 20, and the optical member positioning member and the light source positioning member are fitted to each other via the connecting member. FIG. 15 is a cross section view of the liquid crystal display device according to the present modification taken along the long side direction, illustrating an example where the diffuser 30 and the relay connectors 19 are fixed to each other via the connecting member.

As illustrated in FIG. 15, the diffuser 30 has cutout portions 51 at substantially the center of the end portions on the short side. The cutout portions 51 have a cut-out shape and correspond to the optical member positioning member. The relay connectors 19 include the body portions 19a and groove-shaped connector-side recesses 52 (corresponding to the light source positioning member) formed in the upper surface of the body portions 19a facing the diffuser 30, as in the first modification. The plate holding portions 20a of the holders 20 include positioning insertion holes 53 formed at the positions where the cutout portions 51 and the connector-side recesses 52 overlap with each other. In addition, according to the present modification, connecting members 50 formed in substantially rectangular parallelepiped are inserted through the positioning insertion holes 53. The connecting members 50 extend into both the diffuser-side cutout portions 51 of the diffuser 30 and the connector-side recesses 52 of the relay connectors 19 and are fixed therein. The connecting members 50 have a columnar shape extending along the Z-axis direction, and include diffuser-side convex portions 50a on one end facing the front side and connector-side convex portions 50b on the other end facing the back side.

The connecting members 50 are fixed and positioned with respect to the relay connectors 19 when the connector side convex portions 50b are fitted to the recesses 52 of the relay connectors 19. The holders 20 are disposed over the relay connectors 19 from the front side such that the connecting members 50 are inserted through the positioning insertion holes 53 of the holders 20. After the holders 20 are fixed to the chassis 14, the diffuser 30 is mounted onto the plate holding portions 20a of the holders 20 such that the diffuser-side cutout portions 51 of the diffuser 30 is fitted to the diffuser side convex portions 50a protruding from the connecting members 50. In this way, the diffuser 30 can be fixedly positioned with respect to the connecting members 50. Thus, by fitting the recesses 52 of the relay connectors 19 to the cutout portions 51 of the diffuser 30 via the connecting members 50, the hot cathode tube 18 fixed to the relay connectors 19 and the diffuser 30 can be fixed at the normal position. In accordance with the present modification using the connecting members 50, effects similar to those in the first embodiment or the first modification can be obtained. In addition, the relay connectors 19, the holders 20, and the diffuser 30 do not require convex portions and therefore can be easily shaped.

### Third Modification of the First Embodiment

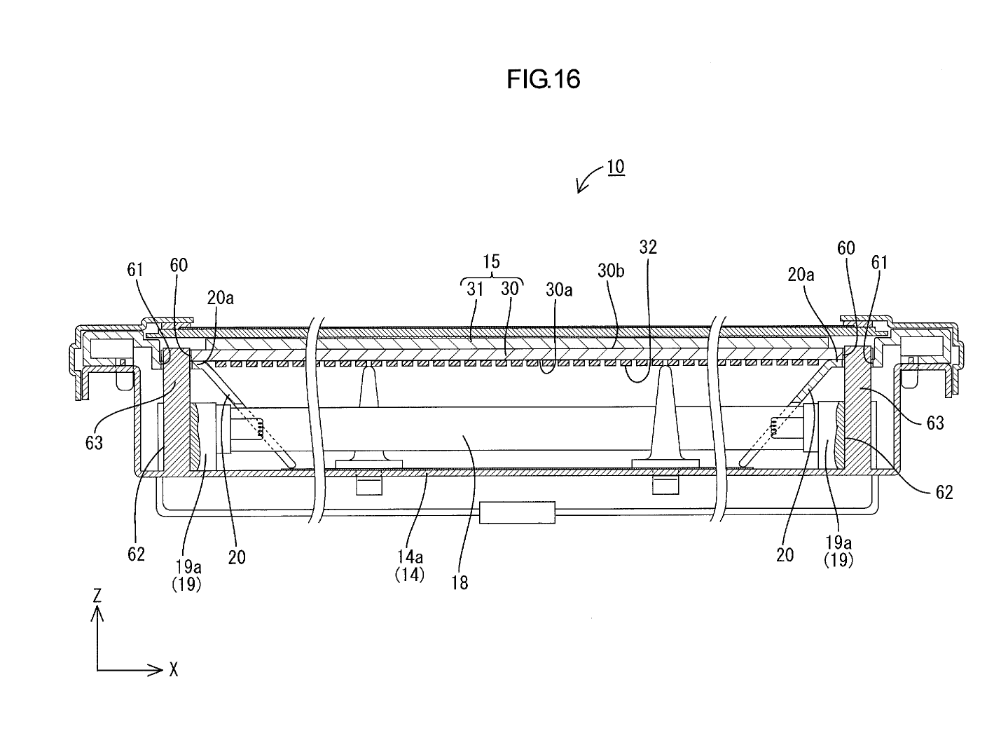

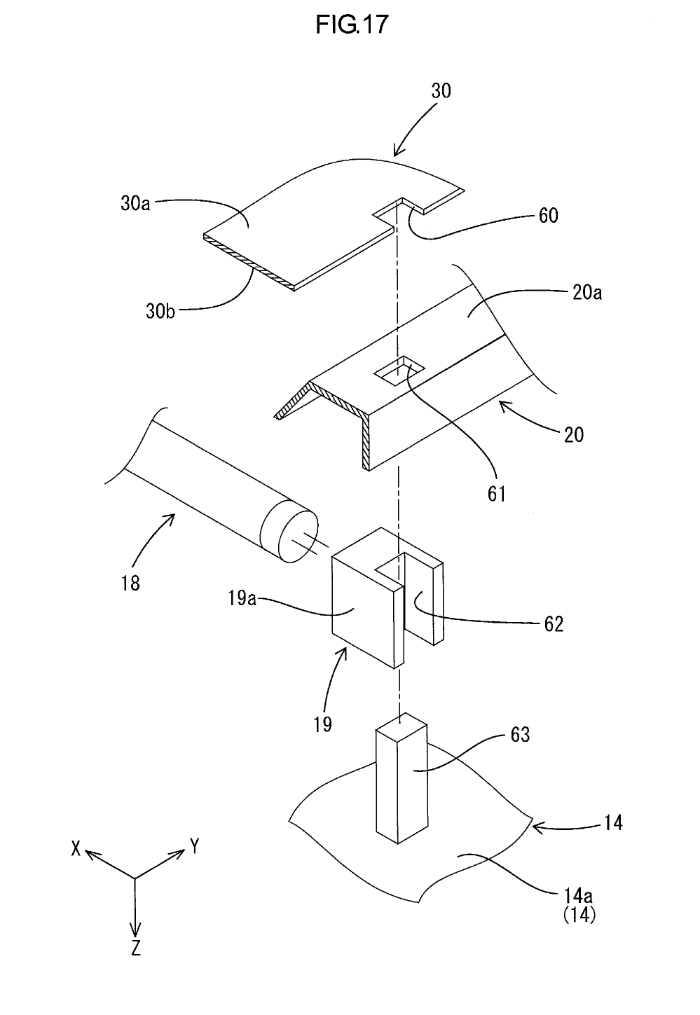

The third modification of the first embodiment will be described with reference to FIGS. 16 and 17. The third modification differs from the first embodiment and the first and second modifications in the location of the light source positioning member. FIG. 16 is a cross section view of the liquid crystal display device according to the present modification taken along the long side direction, in which the light source positioning member is disposed on the chassis 14. FIG. 17 is a perspective view of major components of the positioning member of FIG. 16.

As illustrated in FIGS. 16 and 17, the diffuser 30 includes cutout portions 60 disposed at substantially the center position of both of the short-side end portions thereof as in the foregoing embodiment. The plate holding portions 20a of the holders 20 include positioning insertion holes 61 at positions that communicate with the cutout portions 60 when the diffuser 30 is mounted. Further, the relay connectors 19 have groove portions 62, each having a cut-out shape and a vertically penetrating form, at end portions opposite to the portions connected with the hot cathode tube 18. The cutout portions 60 and the groove portions 62 are aligned with each other. At both short-side end portions of the bottom plate 14a of the chassis 14 in the middle portion 14C (see FIG. 5), a pair of pin portions 63 is provided. The pin portions 63 are fitted to the cutout portions 60 of the diffuser 30 and the groove portions 62 of the relay connectors 19, and can be inserted through the positioning insertion holes 61 of the holders 20. The pin portions 63 have a columnar shape extending along the Z-axis direction and are dimensioned to have a length such that an upper-end face of the pin portions 63 is substantially flush with the second surface 30b of the diffuser 30 in a state where the diffuser 30 is mounted.

The relay connectors 19 are fixed to the chassis 14 while the groove portions 62 are fitted to the pin portions 63 of the chassis 14. Then, the pin portions 63 protruding from the body portions 19a of the relay connectors 19 are inserted into the positioning insertion holes 61 of the holders 20, and the holders 20 are fixed to the bottom plate 14a of the chassis 14. Thereafter, the diffuser 30 is mounted onto the plate holding portions 20a such that the cutout portions 60 of the diffuser 30 are fitted to the pin portions 63 protruding from the plate holding portions 20a of the holders 20. By fixing the relay connectors 19 and the diffuser 30 to the pin portions 63 of the chassis 14, the relay connectors 19 and the diffuser 30 can be positioned. In this way, the hot cathode tube 18 and the diffuser 30 fixed to the relay connectors 19 can be held at the normal position, thereby preventing uneven brightness from occurring.

### Fourth Modification of the First Embodiment

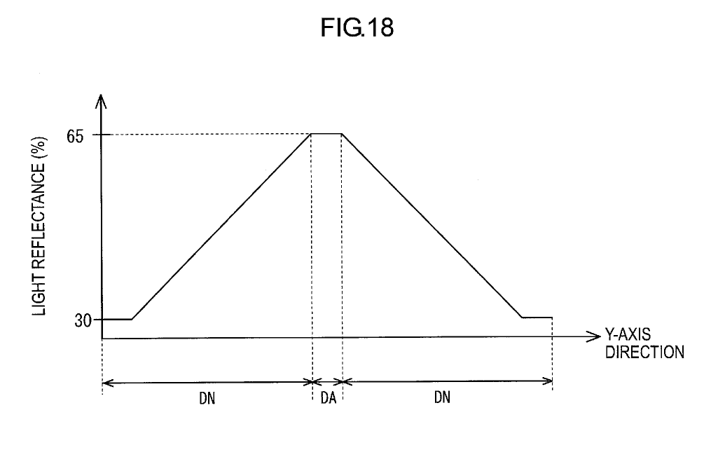

The fourth modification of the first embodiment will be described with reference to FIG. 18. The present modification differs from the first embodiment and the first through third modifications in the light reflectance of the diffuser 30 in the short side direction (Y-axis direction) thereof. FIG. 18 is a graph schematically showing a change in light reflectance of the diffuser according to the fourth modification in the short side direction.

In the present modification, the diffuser 30 has a distribution of light reflectance other than the normal distribution. In this case, too, the positioning structures according to the foregoing embodiments can be applied. As illustrated in FIG. 18, in the light source overlapping portion DA, the light reflectance on the first surface 30a of the diffuser 30 is almost uniform at 65%, for example, which indicates a maximum value. In the light source non-overlapping portions DN, the light reflectance is gradually and continuously decreased (i.e., it varies in a slope manner) along with increase in distance from the light source overlapping portion DA, reaching a minimum value of 30% at the both end portions of the diffuser 30 in the short side direction (Y-axis direction). Due to this structure, the illumination light emitted from the diffuser 30 has a gradual brightness distribution as in the foregoing embodiments.

### Fifth Modification of the First Embodiment

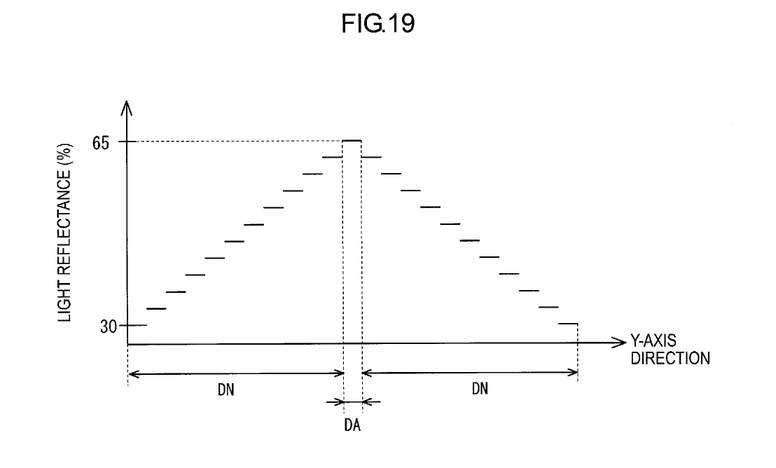

The fifth modification of the first embodiment will be described with reference to FIG. 19. The fourth modification differs from the fourth modification in the distribution of light reflectance of the diffuser 30 in the short side direction (Y-axis direction) thereof. FIG. 19 is a graph schematically showing a change in light reflectance of the diffuser 30 according to the present modification in the short side direction.

The distribution of light reflectance of the diffuser 30 shown in FIG. 19 will be described. The light reflecting portion 32 is formed such that the light reflectance in the plane of the first surface 30a of the diffuser 30 is successively decreased in steps from the light source overlapping portion DA to the light source non-overlapping portions DN. Specifically, the area of the dots 32a (light reflectance) constituting the light reflecting portion 32 is maximum and uniform in the light source overlapping portion DA, while the area is decreased in successive areas as is farther away from the light source overlapping portion DA, reaching a minimum at the both end portions of the diffuser 30 in the short side direction (Y-axis direction). Thus, in the light source non-overlapping portions DN of the light reflecting portion 32, the light reflectance changes in a stripe manner along the short side direction of the diffuser 30 (Y-axis direction). Due to this configuration, the illumination light emitted from the diffuser 30 has a gradual brightness distribution as in the foregoing embodiments. The diffuser 30 having such a plurality of areas with successively varied light reflectance can be manufactured by a simple method, thus contributing to a decrease in costs.

### Second Embodiment

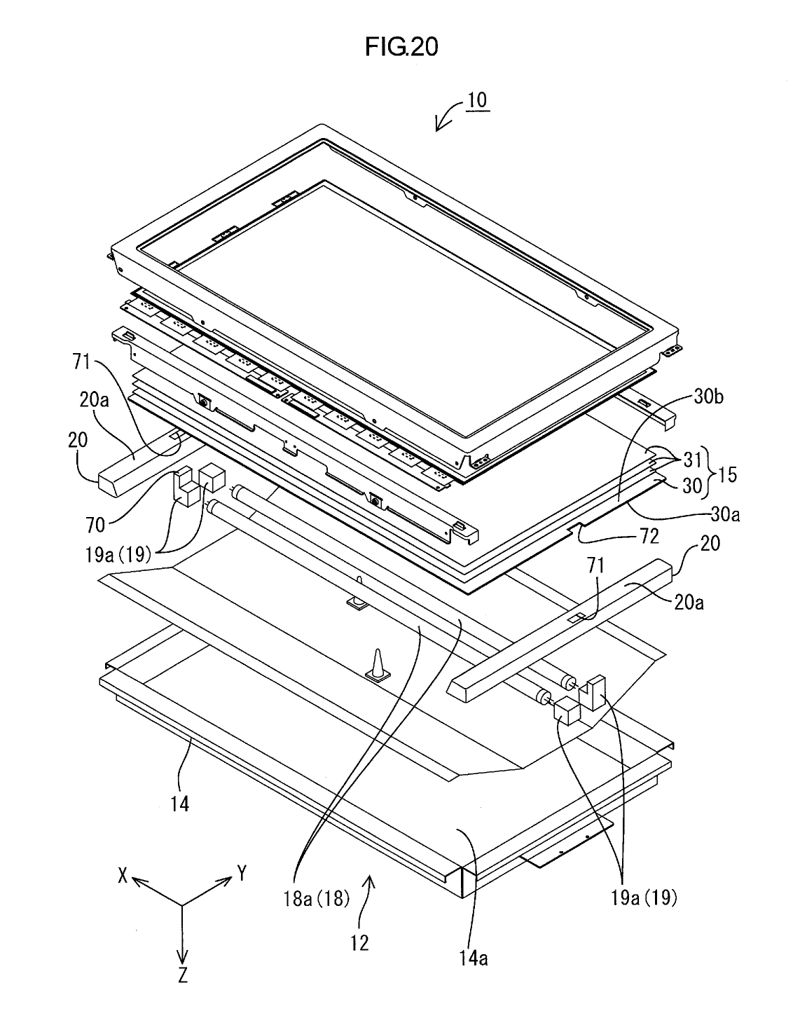

Next, the second embodiment of the present invention will be described with reference to FIGS. 20 to 22. The present embodiment differs from the first embodiment in the number of the hot cathode tubes 18, the number of the relay connectors 19 connected to the hot cathode tubes 18, the manner of installation of the light source positioning member, etc. Other features of the second embodiment are similar to those of the first embodiment and therefore their description will be omitted.

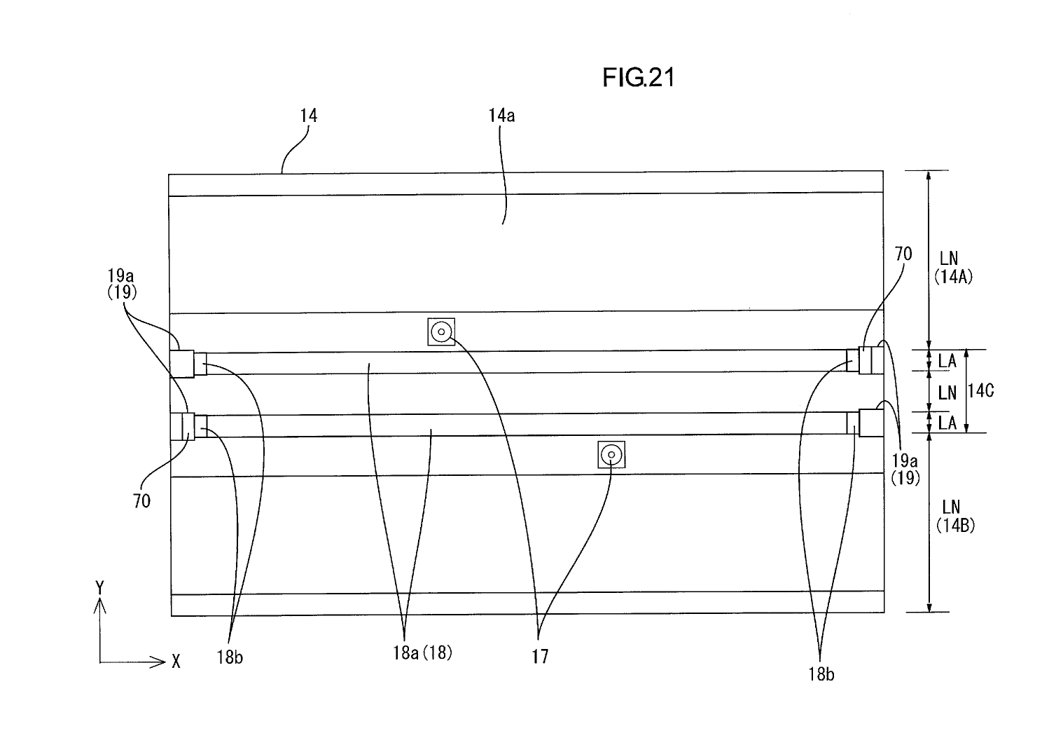

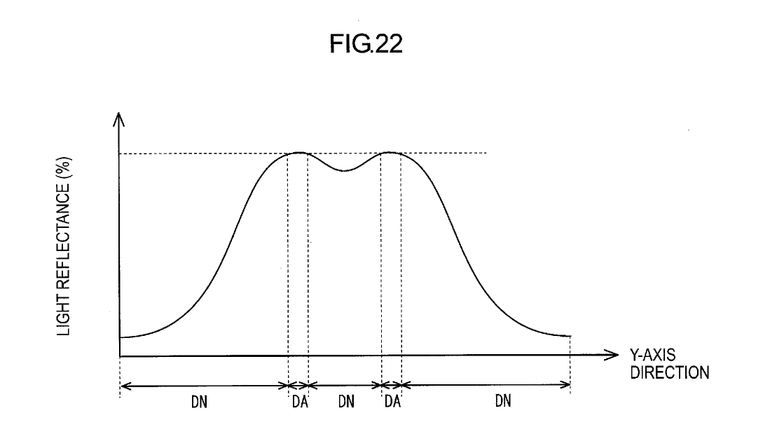

FIG. 20 is an exploded perspective view showing a schematic configuration of the liquid crystal display device according to the present embodiment. FIG. 21 is a plan view showing a layout of the hot cathode tubes, the chassis, the support members, and the connectors of the liquid crystal display device of FIG. 20. FIG. 22 is a graph schematically showing a change in light reflectance of the diffuser according to the present embodiment in the short side direction.

The structure of the present embodiment will be described next. As illustrated in FIGS. 20 and 21, two hot cathode tubes 18 are disposed in parallel with their axial direction aligned with the long side direction of the chassis 14 in the middle portion 14C. The hot cathode tubes 18 are positionally fixed by two pairs of relay connectors 19 which are electrically connected to an inverter (not illustrated). The relay connectors 19 are disposed along the short-side edges of the bottom plate 14a of the chassis 14, as illustrated in FIG. 19. Each of the hot cathode tubes 18 is fixed to each pair of the relay connectors 19. Two of the relay connectors 19 that are diagonally positioned (i.e., the upper-right and lower-left ones of the four relay connectors 19 in FIG. 20) have convex portions 70. The convex portions 70 are formed in substantially rectangular parallelepiped convex portions protruding from front-side surfaces of the body portions 19a of the relay connectors 19 along the short-side edges of the chassis 14. The plate holding portions 20a of the holders 20 that are disposed over the relay connectors 19 has positioning insertion holes 71 into which the convex portions 70 can be inserted. The diffuser 30 has, along the short-side edges, cutout portions 72 which have a cut-out shape. The convex portions 70 inserted through the positioning insertion holes 71 can be fitted to the cutout portions 72.

The dot pattern of the light reflecting portion 32 of the diffuser 30 is varied as in the first embodiment such that the light reflectance on the first surface 30a of the diffuser 30 facing the hot cathode tube 18 is varied along the short side direction, as illustrated in FIG. 22. Specifically, as the present embodiment includes two hot cathode tubes 18 and, there are two light source overlapping portions DA with two light reflectance peaks. In the light source non-overlapping portions DN, the light reflectance is set to become smaller along with increase in distance from the light source overlapping portion DA as in the first embodiment.

According to the present embodiment, because two hot cathode tubes 18 are used, higher brightness can be obtained as compared to the first embodiment where only a single hot cathode tube 18 is used. Further, because two diagonally-positioned relay connectors 19 out of the four relay connectors 19 connected to the hot cathode tubes 18 include the convex portions 70, one of each pair of the relay connectors 19 connected to the end portions of the hot cathode tubes 18 includes the convex portion 70. Thus, the diffuser 30 can be positioned with respect to each of the two hot cathode tubes 18. Therefore, the hot cathode tubes 18 and the diffuser 30 can be positioned more reliably relative to each other, thereby more effectively preventing uneven brightness.

### Third Embodiment

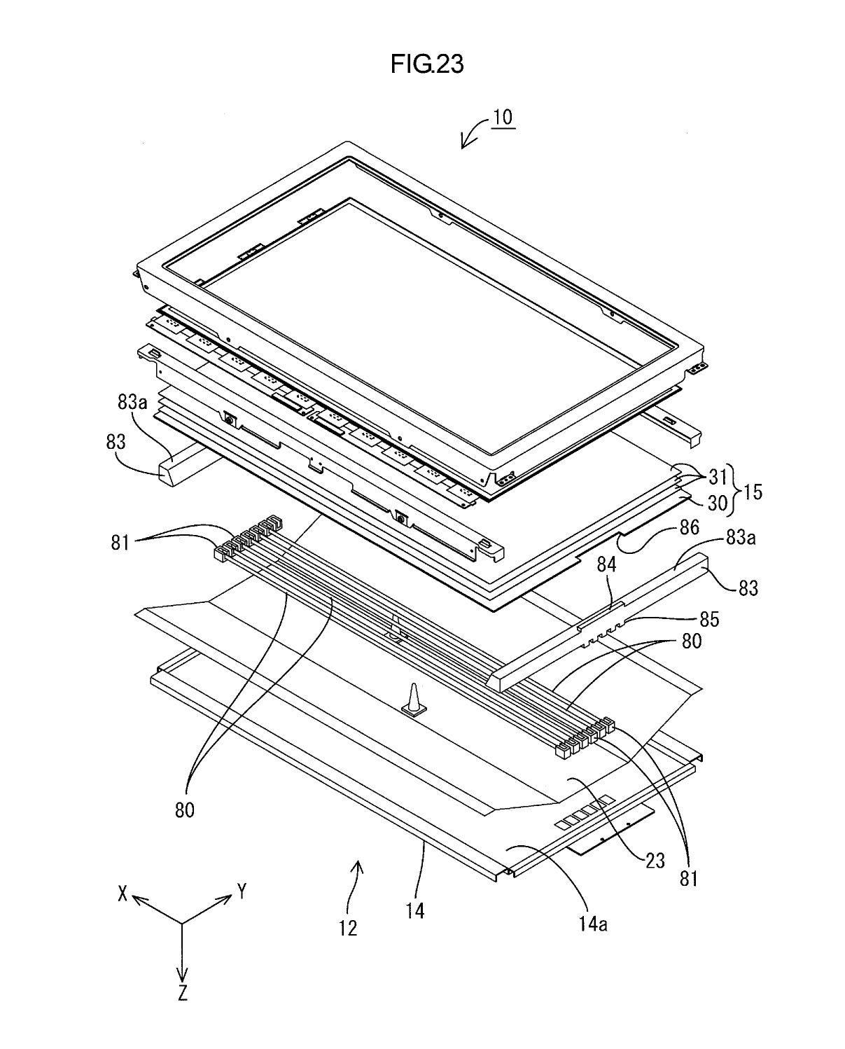

Next, the third embodiment of the present invention will be described with reference to FIGS. 23 to 26. The present embodiment differs from the first and second embodiments mainly in the use of cold cathode tubes 80 as the light source. Members similar to those of the first embodiment will be designated with similar reference numerals, and their illustration in the drawings and description will be omitted.

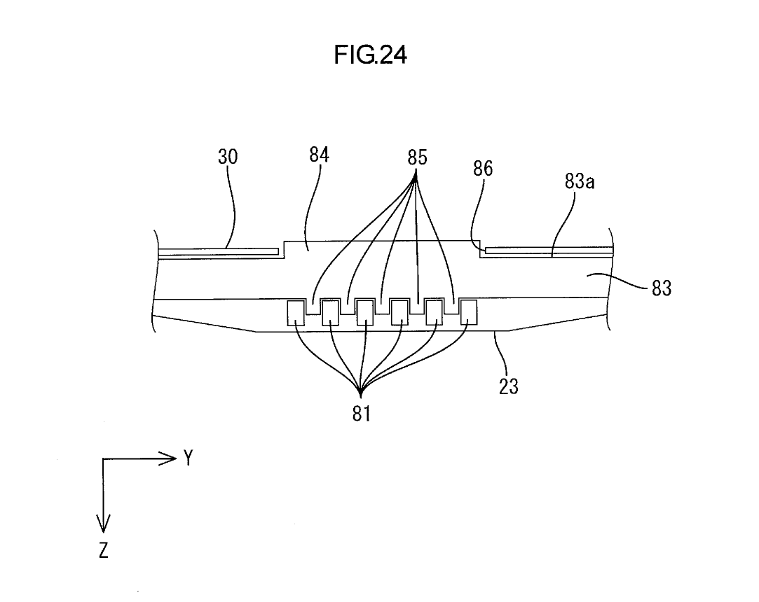

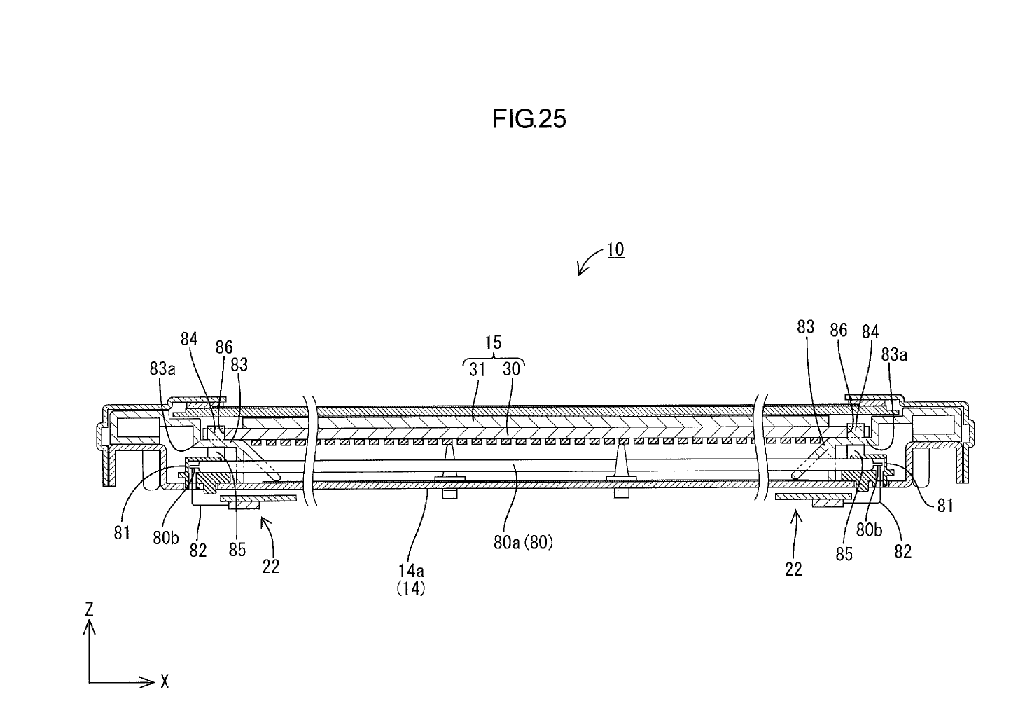

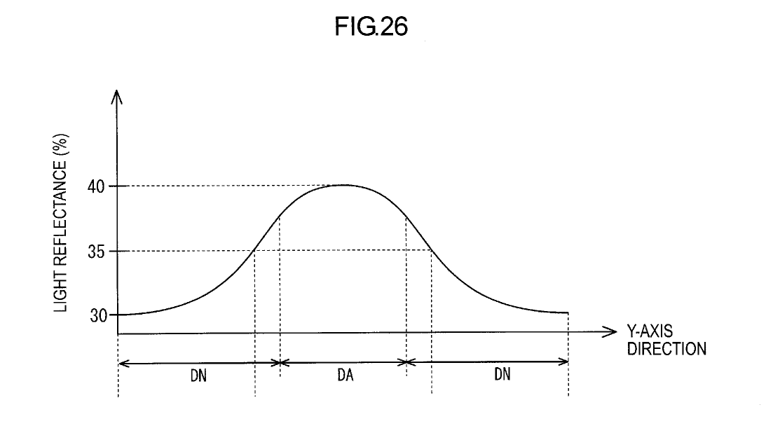

FIG. 23 is an exploded perspective view showing a schematic configuration of the liquid crystal display device according to the present embodiment. FIG. 24 is a partial side view of the liquid crystal display device of FIG. 23, illustrating particularly the positioning area seen from the short side. FIG. 25 is a cross section view of FIG. 23 taken along the long side direction thereof. FIG. 26 is a graph schematically showing a change in light reflectance of the diffuser according to the present embodiment in the short side direction thereof.

According to the present embodiment, as illustrated in FIGS. 23 and 25, the cold cathode tubes 80 as the light source have a slender tubular (linear) shape, each including a hollow slender glass tube 80a with its both end portions closed, and a pair of electrodes 80b contained inside the both end portions of the glass tube 80a. The glass tube contains mercury, a rare gas, or the like, and the inner-wall surfaces are coated with a fluorescent material. Relay connectors 81 are disposed at the end portions of the cold cathode tube 80 and connected to lead terminals 82 protruding from the electrodes 80b to the outside of the glass tube 80a, as illustrated in FIG. 25. The cold cathode tubes 80 are connected via the relay connectors 81 to an inverter substrate 22 mounted on the outer surface side of the bottom plate 14a of the chassis 14 such that the operation of the cold cathode tubes 80 can be controlled. The cold cathode tubes 80 have an outer diameter of about 4 mm, which is smaller than the outer diameter of the hot cathode tube 18 (about 15.5 mm, for example) described in the first embodiment. In the illustrated example, six cold cathode tubes 80 are eccentrically arranged in parallel at predetermined intervals (arrangement pitch) within the chassis 14 in a state where the length direction (axial direction) of the cold cathode tubes 80 is aligned with the long side direction of the chassis 14. The relay connectors 81 are also arranged in parallel in the Y-axis direction, similarly to the cold cathode tubes 80, and the arrangement intervals depend on the cold cathode tubes 80.

The end portions of the cold cathode tubes 80 and the relay connectors 81 are covered by holders 83 having a substantially thin box-like shape extending along the short side direction of the chassis 14, as in the first embodiment. The holders 83 include plate holding portions 83a (surfaces of the holders 83 facing the optical member as illustrated in FIGS. 23 and 25) on which the optical members 15 and the liquid crystal panel 11 can be placed at different levels. At substantially the middle portion of the plate holding portion 83a, convex portions 84 (corresponding to the light source positioning member) are formed. The convex portions 84 are fitted to the diffuser 30 that is one component of the optical members 15 placed on the plate holding portion 83a. On the surface of the holder 83 opposite to the plate holding portion 83a and facing the chassis 14, a plurality of relay-connector-side fitting portions 85 that can be fitted to the gaps of the relay connectors 81 are disposed in parallel. At substantially the center of the short-side end portions of the diffuser 30 that are directly disposed on the plate holding portions 83a of the holders 83, cutout portions 86 (corresponding to the optical member positioning member) are formed. The cutout portions 86 have a cut-out shape and can be fitted to the convex portions 84.

When the holders 83 with the above structure are mounted, as illustrated in FIG. 24, the relay connector-side fitting portions 85 are fitted to the gaps between the relay connectors 81 such that the holders 83 and the relay connectors 81 are positioned. On the other hand, the convex portions 84 on the plate holding portions 83a are fitted to the cutout portions 86 of the diffuser 30, whereby the holders 83 and the diffuser 30 are positioned. Thus, the relay connectors 81 and the diffuser 30 are fixed via the holders 83 so as not to be displaced.

According to the present embodiment, the diffuser 30 has a light reflectance distribution illustrated in FIG. 26, where the light reflectance is continuously decreased from the middle position to the end positions in the short side direction as in the first embodiment. Thus, the distribution is similar to the normal distribution. The light reflectance distribution has a wider light source disposed area LA than in the first embodiment. Therefore, the distribution is more gradual.

Due to this configuration, even in the liquid crystal display device 10 to which the cold cathode tubes 80 are applied, the diffuser 30 can be fixed at the normal position with respect to the cold cathode tubes 80 by providing the convex portions 84 and the cutout portions 86, i.e., the light source positioning member and the optical member positioning member, respectively. As a result, no positional displacement occurs in either member, and hence uneven brightness can be prevented. Therefore, the effect of the light reflectance distribution of the diffuser 30 can be exerted as much as possible. Because the cold cathode tubes 80 have less power consumption than the hot cathode tubes 18, longer operating life can be obtained and lighting control can be easily performed.

### Fourth Embodiment

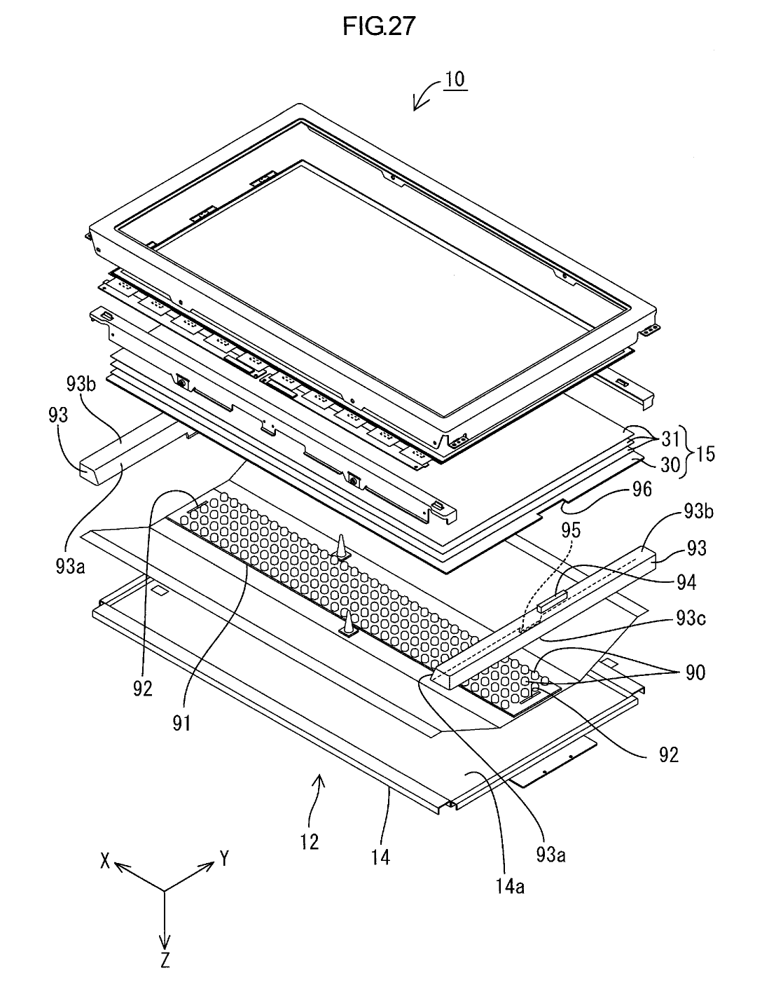

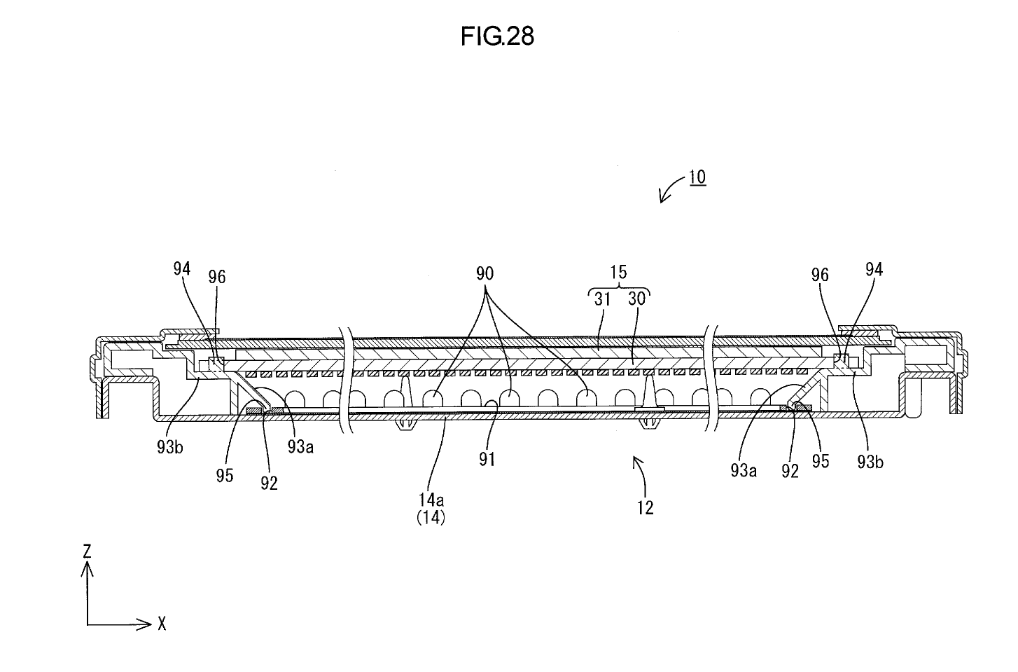

The fourth embodiment of the present invention will be described with reference to FIGS. 27 and 28. The fourth embodiment differs from the first embodiment mainly in that the light source is LEDs 90. Other members similar to those of the first embodiment may be designated with similar reference numerals and their illustration in the drawings and description may be omitted. FIG. 27 is an exploded perspective view showing a schematic configuration of the liquid crystal display device according to the present embodiment. FIG. 28 is a cross section view of the liquid crystal display device of FIG. 27 taken along the long side direction.

As illustrated in FIGS. 27 and 28, a number of the LEDs 90, which is the light source according to the present embodiment, are mounted on a LED board 91 housed in the chassis 14. The LED board 91, which is made of a synthetic resin having a white surface for high light reflectance, is disposed along the bottom plate 14a of the chassis 14 and fixed onto the bottom plate 14a by a fixing means (not illustrated). The LED board 91 has a horizontally-long rectangular shape in plan view and is mounted on the bottom plate 14a in a state where its long side direction is aligned with the long side direction of the chassis 14. The LED board 91 has a short side dimension smaller than the vertical dimension of the screen (or the short side dimension of the chassis 14) and a long side dimension substantially the same as the horizontal dimension of the screen (or the long side dimension of the chassis 14). On the LED board 91, a wiring pattern made of a metal film is formed, and the LEDs 90 are mounted at predetermined positions on the wiring pattern. The LED board 91 is connected to an external control board (not illustrated) that supplies power required for lighting the LEDs 90 and by which the operation of the LEDs 90 can be controlled. The LED board 91 is disposed at a middle portion in the short side direction of the bottom plate 14a of the chassis 14. The LED board 91 is disposed with respect to the chassis 14 in substantially the same manner as the hot cathode tube 18 in the first embodiment and the cold cathode tube 80 in the third embodiment are disposed. Thus, redundant description will be omitted.

The LEDs 90 are surface-mounted on the LED board 91; namely, the LEDs 90 are of the so-called surface-mounted type. A number of the LEDs 90 are disposed on the front-side surface of the LED board 91 in a grid (or a matrix) along the X-axis direction and the Y-axis direction. Each of the LEDs 90 includes a substrate portion fixedly attached to the LED board 91 and an LED chip sealed on top of the substrate portion with a resin material. The LED chips mounted on the substrate portion are of three types with different main emission wavelengths. Specifically, each LED chip is configured to emit the single color of R (red), G (green), or B (blue), and the LEDs 90 as a whole can emit white light. The LEDs 90 are of a top type where the emitting surface is on the side opposite to the mounting surface with respect to the LED board 91. The LEDs 90 have an optical axis substantially aligned with the Z-axis direction (orthogonal to the planes of the liquid crystal panel 11 and the optical members 15).

Between the chassis 14 in which the LED board 91 is disposed and the optical members 15 including the diffuser 30, light directing portions 93 that are substantially box-shaped and slender and extend along the short side direction of the chassis 14 are disposed. The light directing portions 93 are disposed on both end portions of the chassis 14 along the short sides on a one-each basis. The light directing portions 93 include inner side-wall portions 93a forming side walls on the middle portion side of the backlight unit 12. The inner side-wall portions 93a have an angle of between 90° and 180° with respect to upper surface portions 93b on which the diffuser 30 is disposed. The inner side-wall portions 93a reflect the light in the chassis 14; therefore, the reflected light can be directed toward the center of the screen. Thus, the light source non-disposed areas LN, particularly the short-side end portions thereof, can be prevented from being visually recognized as dark portions.

At middle portions in the long side direction of the upper surface portions 93b of the light directing portions 93, convex portions 94 that are fitted to the diffuser 30 are provided. On bottom surface portions 93c on the opposite side (facing the LED board 91), convex LED-side fitting portions 95 that can be fitted to the LED board 91 are formed. The convex portions 94 and the LED-side fitting portions 95 are both substantially cuboidal and serve as the light source positioning member.

The LED board 91 includes groove-shaped fitting portions 92 formed at the end portions in the long side direction and at substantially the middle portion in the short side direction, the fitting portions 92 fitted to the LED-side fitting portions 95. The fitting portions 92 include substantially rectangular openings along the short side direction of the LED board 91. Further, the diffuser 30 includes cutout portions 96 at substantially the middle position of the short-side end portions, the cutout portions 96 serving as the optical member positioning member. The cutout portions 96 are configured to be fitted to the convex portions 94 extending upright on the light directing portions 93; therefore, the diffuser 30 can be fixed with respect to the light directing portions 93. The LED-side fitting portions 95 are configured to be inserted into and fitted to the fitting portions 92; therefore, the light directing portions 93 can be fixed with respect to the LED board 91. Thus, the diffuser 30 can be fixed at the normal position on the LED board 91 via the light directing portions 93 with respect to the X-axis direction and the Y-axis direction, thereby preventing positional displacement from the normal position.

Due to the above-described configuration, the LEDs 90 mounted on the LED board 91 and the diffuser 30 can be fixed at the normal position via the light directing portions 93. Compared to the hot cathode tube 18 in the first embodiment and the cold cathode tube 80 in the third embodiment, the LEDs 90 have higher directionality of the emitted light. Thus, the LEDs 90 need to be very accurately positioned with respect to the diffuser 30. In this respect, the present embodiment enables the diffuser 30 and the LEDs 90 to be reliably fixed at the normal position as in the foregoing embodiments, by the use of the light directing portions 93. Thus, uneven brightness can be appropriately prevented.

By using the LEDs 90 as the light source, long operating life can be obtained and power consumption can be reduced.

### Other Embodiments

The present invention is not limited to any of the foregoing embodiments described with reference to the drawings and may include the following embodiments in its technical scope.

(1) In the foregoing embodiments, the diffuser 30 includes the optical member positioning member. This is merely an example. In another example where the optical members 15 include the optical sheet 31 having anisotropy in its optical characteristics, the optical member positioning member may be provided in the optical sheet 31. In this way, even when the optical sheet 31 has anisotropy in its optical characteristics, positional displacement with respect to the light source can be prevented. Therefore, the optical characteristics of the optical sheet 31 can be exerted as much as possible.

(2) In the foregoing embodiments, the diffuser 30 has the cutout portions in a substantially square cut-out shape. This is merely an example. The cutout portions may be in a substantially semicircular cut-out shape, for example. In this case, the convex portions on the opposite side need to have a substantially semicircular columnar shape that can be fitted to the cutout portions. The cutout portions may include a hole formed through the diffuser 30, or a simple depression that does not penetrate through the recess diffuser 30.

(3) In the second embodiment, the convex portions 70 are provided for two of the four relay connectors 19 that are located at the diagonal positions. This is merely an example. The convex portions 70 may be provided for two relay connectors 19 located at end portions on either side of the diffuser 30 in the long side direction, or for the relay connectors 19 located at the end portions of one of the two hot cathode tubes 18. Further, the convex portions 70 may be provided for all or one of the four relay connectors 19.

(4) In the fourth embodiment, the light directing portions 93 include the convex LED-side fitting portions 95 while the LED board 91 includes the recessed fitting portions 92. This is merely an example. The cutout/convex relationship may be reversed such that the light directing portions 93 may include the recessed fitting portions 95 while the LED board 91 may include the convex fitting portions.

(5) In the foregoing embodiments, the cutout portions are provided on the diffuser 30 side while the convex portions are provided on the light source side. This is merely an example. Preferably, the cutout/convex relationship may be reversed such that the convex portions are provided on the diffuser 30 side while the cutout portion may be provided on the light source side. In this case, the convex portions may be integrally formed with the diffuser 30 side. Alternatively, the convex portions may be provided as separate components from the diffuser 30 and configured to be attached to the diffuser 30.

(6) In the foregoing embodiments, the light source positioning member and the optical member positioning member are integrally formed with the respective members of the liquid crystal display device. This is merely an example. The positioning members may be formed as separate components configured to be attached to the light source side or the optical member side.

(7) In the first and second embodiments, one or two hot cathode tubes 18 are used as the light source. However, the number of the hot cathode tubes 18 to be used may be changed, such as to three or more. When three or more hot cathode tubes are used, the ratio of the light source disposed area LA may be adjusted in proportion to the number of the tubes, based on the ratio of the light source disposed area LA with respect to the vertical dimension of the screen according to the foregoing embodiments.

(8) In the third embodiment, six cold cathode tubes 80 are used as the light source, but the number of the cold cathode tubes 80 may be changed to five or less or to seven or more. For example, when four cold cathode tubes 80 are used, the ratio of the light source disposed area LA with respect to the vertical dimension of the screen may be preferably about 26%. When eight cold cathode tubes 80 are used, the ratio of the light source disposed area LA with respect to the vertical dimension of the screen may be preferably about 58%. When the number of the cold cathode tubes 80 to be used is other than those, the ratio of the light source disposed area LA may be adjusted in proportion to the number of the cold cathode tubes 80 to be used.

(9) In the fourth embodiment, the size of the LED board 91 with respect to the chassis 14, and the installation location and number of the LEDs 90 on the LED board 91 may be appropriately changed.

(10) In the foregoing embodiments, the middle portion 14C of the chassis 14 corresponds to the light source disposed area LA, and each of the first end portion 14A and the second end portion 14B corresponds to the light source non-disposed area LN. Preferably, at least either the first end portion 14A or the second end portion 14B of the chassis 14 may correspond to the light source disposed area LA, and the other portions may correspond to the light source non-disposed areas LN. In this case, the first end portion 14A and the middle portion 14C may correspond to the light source disposed area LA, or the second end portion 14B and the middle portion 14C may correspond to the light source disposed area LA.

(11) The distributions of the light reflectance of the diffuser 30 according to the foregoing embodiments are merely examples. When, for example, the ratio between the light source disposed area LA and the light source non-disposed areas LN is changed, it is preferable that the distribution of the light reflectance of the diffuser 30 be changed accordingly. For example, the diffuser 30 may have a light reflectance distribution that is constant in the light source overlapping portion DA and the light source non-overlapping portions DN.

(12) In the foregoing embodiments, the light source extends along the long side direction of the chassis (X-axis direction), the light source disposed area LA and the light source non-disposed areas LN are arranged in parallel along the short side direction of the chassis 14 (Y-axis direction), and the light reflectance of the diffuser 30 is varied along the short side direction of the chassis 14. Preferably, the light source may extend along the short side direction of the chassis 14 (Y-axis direction), the light source disposed area LA and the light source non-disposed areas LN may be arranged in parallel along the long side direction of the chassis 14 (X-axis direction), and the light reflectance of the diffuser 30 may be varied along the long side direction of the chassis 14.

(13) In the foregoing embodiments, the dots 32a in the dot pattern of the light reflecting portion 32 are circular. This is merely an example. The shape of the dots 32a is not limited thereto and may be elliptical, diagonal, etc.

(14) In the foregoing embodiments, the light reflecting portion 32 is formed on the surface of the diffuser 30 by printing. A film-like member having the light reflecting portion 32 may be attached onto the diffuser 30. Preferably, the light reflecting portion 32 may be formed by other methods such as metal deposition.

(15) In the foregoing embodiments, the light reflectance in the plane of the diffuser 30 is adjusted by forming the light reflecting portion 32 on the surface of the diffuser 30. The light reflectance of the diffuser 30 may be adjusted as follows. Generally, the diffuser 30 includes a light transmissive substrate in which light scattering particles are dispersed. Thus, the light reflectance of the diffuser 30 can be determined by the compounding ratio (wt %) of the light scattering particles to the light transmissive substrate. Specifically, the light reflectance can be relatively increased by relatively increasing the compounding ratio of the light scattering particles, while the light reflectance can be relatively decreased by relatively decreasing the compounding ratio of the light scattering particles. When the compounding ratio of the light scattering particles has a distribution as described above, anisotropy occurs in the light-scattering performance (optical characteristics) in the plane of the diffuser 30. The present invention can be suitably applied to the diffuser 30 having such optical characteristics.

(16) In the foregoing embodiments, the light reflectance of the diffuser 30 is designed or controlled by varying the area of the dots 32a constituting the light reflecting portion 32. Preferably, the light reflectance may be controlled by, for example, varying the arrangement interval of the dots 32a that have the same area, or by forming the dots 32a with different light reflectance. The dots with different light reflectance may be formed by using a plurality of materials having different light reflectance.

(17) In the foregoing embodiments, the light reflecting portion 32 is formed on the diffuser 30 of the optical members 15, and the light reflectance of the light reflecting portion 32 is appropriately controlled. Preferably, the light reflecting portion 32 may be formed on another of the optical members 15 other than the diffuser 30, and the light reflectance may be appropriately controlled. The numbers and types of the diffuser 30 and the optical sheet 31 to be used as the optical members 15 may be appropriately changed.

(18) In the foregoing embodiments, uneven brightness in the illumination light emitted from the optical members 15 is prevented by appropriately controlling the light reflectance of the optical members 15. Preferably, the light transmittance (light shielding ratio) of the optical members 15 may be appropriately controlled. In this case, the light reflectance and a light diffusing rate which will be described later may be constant or adjusted appropriately in accordance with the light transmittance (light shielding ratio) in order to prevent uneven brightness in the illumination light emitted from the optical members 15. For example, uneven brightness in the illumination light exited from the optical members 15 is prevented by controlling the light shielding rate of a shielding plate, as will be described below.

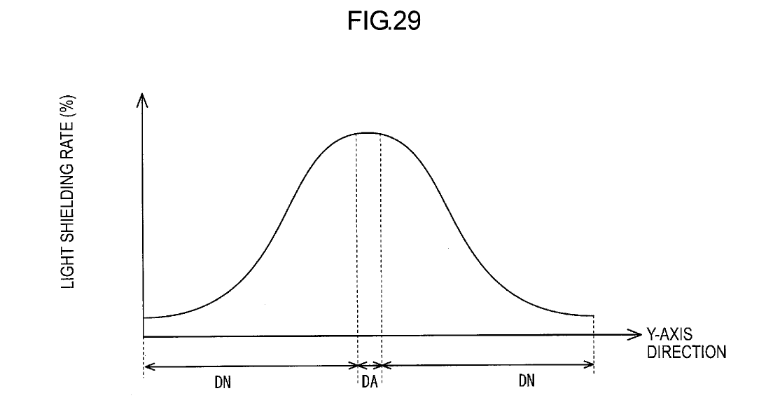

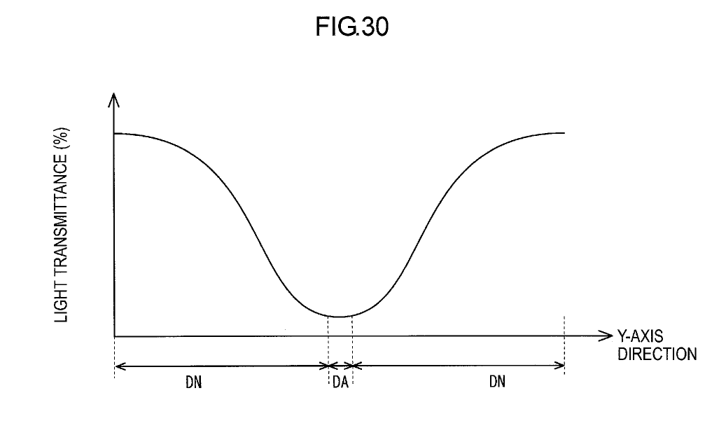

For example, when the light source is disposed in the same way as in the first embodiment, the light shielding rate on the surface of the shielding plate (not illustrated) facing the hot cathode tube 18 is varied along the short side direction as illustrated in FIG. 29, such that the light shielding rate in the light source overlapping portion DA is greater than that in the light source non-overlapping portions DN. In this way, the same effect as when the light reflectance is appropriately controlled in the foregoing embodiments can be obtained. When the light transmittance is appropriately controlled, the light transmittance may preferably have a distribution such that the light transmittance is at a minimum at the light source overlapping portion DA and is gradually increased toward the light source non-overlapping portions DN along the short side direction, as illustrated in FIG. 30.

The present invention can be suitably applied also when the optical members 15 have different distributions of the light shielding ratio and the light transmittance.

(19) In the foregoing embodiments, uneven brightness in the illumination light emitted from the optical members 15 is prevented by appropriately controlling the light reflectance of the optical members 15. Preferably, uneven brightness in the illumination light emitted from the optical members 15 may be prevented by appropriately controlling the light diffusing ratio of the diffuser 30. In this case, the light reflectance and the light transmittance (light shielding ratio) of the optical members 15 may be constant or adjusted appropriately in accordance with the light diffusing ratio in order to prevent uneven brightness in the illumination light emitted from the optical members 15.

For example, when the light source is disposed in the same way as in the first embodiment, the light diffusing ratio in the light source overlapping portion DA of the first surface 30a of the diffuser 30 is relatively increased, while the light diffusing ratio in the light source non-overlapping portions DN is relatively decreased, as in the case of the light shielding ratio illustrated in FIG. 29. In this way, by appropriately controlling the light diffusing ratio, the same effect as when the light reflectance is appropriately controlled as in the foregoing embodiments can be obtained. The present invention can be appropriately applied also to the lighting device having the diffuser 30 with such optical characteristics.

The light diffusing ratio of the diffuser 30 may be controlled by, for example, forming the first surface 30a of the diffuser 30 in a concave-convex shape, or varying the thickness of the diffuser 30. In the method of forming the first surface 30a in a concave-convex shape, the area of each of the concave or convex portions and the forming ratio of the concave-convex shape are designed to be decreased in the light source overlapping portion DA compared to the light source non-overlapping portions DN. In this way, the distribution of light diffusing ratio illustrated in FIG. 30 can be obtained. Specifically, in the first surface 30a of the diffuser 30, a small number of small concave portions are formed in the light source overlapping portion DA, while in the light source non-overlapping portions DN, a large number of concave portions larger than the concave portions in the light source overlapping portion DA are formed. In the method of varying the thickness of the diffuser 30, the thickness in the light source overlapping portion DA is maximized while the thickness is gradually decreased from the light source overlapping portion DA toward the light source non-overlapping portion DN. In this way, the distribution of light diffusing ratio illustrated in FIG. 30 can be obtained.

(20) In the first to third embodiments, the light source is the hot cathode tube 18 or the cold cathode tube 80, each of which is one type of fluorescent tube (linear light source). Preferably, the light source may be other type of fluorescent tube or a different type of discharge tube (such as a mercury lamp) other than the fluorescent tube.

(21) In the fourth embodiment, the light source is an LED, which is one type of point light source. Preferably, other type of point light source may be used. A planar light source such as an organic EL light source may be used.

(22) In the foregoing embodiments, one type of light source is used. Preferably, a plurality of types of light sources may be combined. Specifically, the hot cathode tube 18 and the cold cathode tube 80 may be combined; the hot cathode tube 18 and the LEDs 90 may be combined; the cold cathode tube 80 and the LEDs 90 may be combined; or the hot cathode tube 18, the cold cathode tube 80, and the LEDs 90 may be combined.

(23) Other than the embodiments described above, the screen size or aspect ratio of the liquid crystal display device 10 may be appropriately changed. For example, the liquid crystal display device 10 (such as the chassis 14) may have a square shape in plan view.

(24) In the foregoing embodiments, the liquid crystal panel 11 and the chassis 14 are disposed in an upright manner with their short side directions aligned with the vertical direction. Preferably, the liquid crystal panel 11 and the chassis 14 may be disposed in an upright manner with their long side directions aligned with the vertical direction.

(25) In the foregoing embodiments, the switching component of the liquid crystal display device 10 is TFTs. Switching components other than TFTs (such as thin-film diodes (TFD)) may be used in the liquid crystal display device. The liquid crystal display device may be configured to provide a monochrome display as well as a color display.

(26) In the foregoing embodiments, the liquid crystal display device 10 includes the liquid crystal panel 11 as a display panel. The display device may include other type of display panel.

(27) In the foregoing embodiments, the television receiver includes a tuner. The display device may not include a tuner.

1. A lighting device comprising:
a light source;
a chassis housing the light source;
an optical member disposed on a light exit side with respect to the light source, the optical member including a portion overlapping with the light source and a portion that does not overlap with the light source, and the portion overlapping with the light source and the portion that does not overlap with the light source have different optical properties;
a light source positioning member disposed on a light source side and configured to position the light source with respect to the optical member; and
an optical member positioning member disposed on an optical member side and configured to position the optical member with respect to the light source and fitted to the light source positioning member, wherein:
the fitting of the light source poisoning member and the optical member positioning member positions the light source and the optical member with respect to each other in a direction along a plate surface of the optical member.

2. The lighting device according to claim 1, further comprising:
a power supply board configured to supply drive power to the light source; and
a relay connector fixed to the chassis and configured to relay supply of power between the power supply board and the light source, wherein:
the light source positioning member includes a convex portion provided on the relay connector;
the optical member positioning member includes a cutout portion formed in the optical member; and
the convex portion and the cutout portion are fitted to each other.

3. The lighting device according to claim 1, further comprising:
a power supply board configured to supply drive power to the light source;
a relay connector fixed to the chassis and configured to relay supply of power between the power supply board and the light source; and
a covering portion covering the relay connector and an end portion of the light source, the covering portion being fixedly positioned with respect to the light source, wherein:
the light source positioning member includes a convex portion provided on the covering portion;
the optical member positioning member includes a cutout portion formed in the optical member; and
the convex portion and the cutout portion are fitted to each other.

4. The lighting device according to claim 1, wherein the light source is a hot cathode tube.

5. The lighting device according to claim 1, wherein the light source is a cold cathode tube.

6. The lighting device according to claim 1, wherein the light source is an LED.

7. The lighting device according to claim 1, wherein:
the light source includes an LED board housed in the chassis and an LED mounted on the LED board;
the light source positioning member includes a convex portion provided on the LED board;
the optical member positioning member includes a cutout portion formed in the optical member; and
the convex portion and the cutout portion are fitted to each other.

8. The lighting device according to claim 1, wherein:
the light source includes an LED board housed in the chassis and an LED mounted on the LED board;
the LED board has a light directing member on its two side portions and the light directing member is fixed to the LED board and configured to direct light from the LED toward a middle portion of the LED board;
the light source positioning member includes a convex portion provided on the light directing portion;
the optical member positioning member includes a cutout portion formed in the optical member; and
the convex portion and the cutout portion are fitted to each other.

9. The lighting device according to claim 1, further comprising a connecting member, wherein the light source positioning member and the optical member positioning member are fitted to each other via the connecting member so as to position the light source and the optical member.

10. The lighting device according to claim 1, wherein the optical properties include light reflectance, and the optical member has different light reflectance between the portion overlapping with the light source and the portion that does not overlap with the light source.

11. The lighting device according to claim 10, wherein the light reflectance of the optical member is lowered as is farther away from the light source.

12. The lighting device according to claim 1, wherein the optical member includes a light reflecting portion disposed on a surface facing the light source and having a light reflectance higher than the optical member.

13. The lighting device according to claim 12, wherein the light reflecting portion includes a number of dots having light reflectivity and each of the dots is formed in substantially a point in a plane surface of the optical member facing the light source.

14. The lighting device according to claim 1, wherein the optical properties include light transmittance, and the optical member has different light transmittance between the portion overlapping with the light source and the portion that does not overlap with the light source.

15. The lighting device according to claim 14, wherein the light transmittance of the optical member is increased as is father away from the light source.

16. The lighting device according to claim 1, wherein the optical properties include light diffusion rate, the optical member has a different light diffusion rate between the portion overlapping with the light source and the portion that does not overlap with the light source.

17. The lighting device according to claim 16, wherein the light diffusion rate of the optical member is decreased as is farther away from the light source.

18. The lighting device according to claim 1, wherein the optical member includes a light diffuser member configured to diffuse the light from the light source, and the light diffuser member has a higher light diffusion rate in the portion overlapping with the light source than in the portion that does not overlap with the light source.

19. The lighting device according to claim 18, wherein the light diffuser member has a plate-like shape and has a thickness that is maximum in the portion overlapping with the light source and is gradually decreased as is closer to the portion that does not overlap with the light source.

20. The lighting device according to claim 18, wherein:
the light diffuser member includes a concave-convex shape on a surface facing the light source;
the concave-convex shape includes a concave portion and a convex portion; and
the area of each of the concave portion and the convex portion and the ratio of formation of the concave-convex shape are smaller in the portion overlapping with the light source than in the portion that does not overlap with the light source.

21. The lighting device according to claim 1, wherein:
the optical member includes a light shielding member configured to block the light from the light source; and
the light shielding member has a higher light shielding rate in the portion overlapping with the light source than in the portion that does not overlap with the light source.

22. The lighting device according to claim 1, wherein:
the chassis includes a portion facing the optical member; the portion of the chassis includes at least a first end portion, a second end portion disposed on an end opposite to the first end portion, and a middle portion disposed between the first end portion and the second end portion; and
the light source is disposed in the middle portion and no light source is disposed in the first end portion and the second end portion.

23. The lighting device according to claim 1, wherein:
the chassis is rectangular in plan view;
the light source extends along a long side direction of the chassis; and
the chassis includes a light source arrangement area in which the light source is disposed and a light source non-arrangement area in which no light source is disposed, and the light source arrangement area and the light source non-arrangement area are provided in parallel to each other in a short side direction of the chassis.

24. The lighting device according to claim 1, wherein:
the chassis is rectangular in plan view;
the light source extends along a long side direction of the chassis;
the chassis includes a light source arrangement area in which the light source is disposed and a light source non-arrangement area in which no light source is disposed; and
the light source arrangement area and the light source non-arrangement area are disposed in parallel to each other in the long side direction of the chassis.

25. A display device comprising:
the lighting device according to claim 1; and
a display panel configured to provide a display by using light from the lighting device.

26. The display device according to claim 25, wherein the display panel is a liquid crystal panel having liquid crystal contained between a pair of substrates.

27. A television receiver comprising the display device according to claim 25.
